(19) United States
(12) Patent Application Publication
(10) Pub. No.: US 2024/0356217 A1
(43) Pub. Date: Oct. 24, 2024

(54) SPATIAL DIVERSITY WITH CONTROLLABLE REFLECTIVE SURFACE

(71) Applicant: QUALCOMM Incorporated, San Diego, CA (US)

(72) Inventors: Danlu Zhang, San Diego, CA (US); Yu Zhang, San Diego, CA (US); Tingfang Ji, San Diego, CA (US); Allen Minh-Triet Tran, Rancho Santa Fe, CA (US)

(21) Appl. No.: 18/686,111

(22) PCT Filed: Oct. 6, 2021
(86) PCT No.: PCT/CN2021/122518

§ 371 Date: Feb. 23, 2024

(51) Int. Cl. H01Q 3/46; H01Q 15/14; H04B 7/04

(52) U.S. Cl. CPC H01Q 3/46; H01Q 15/148; H04B 7/04013

(57) ABSTRACT

Aspects of the disclosure relate to a controllable reflective surface (e.g., reconfigurable intelligent surfaces (RIS)) that reflects in multiple directions simultaneously. The controllable reflective surface may include an array of reflecting elements, each reflecting element comprising a radiating component and a phase-shifting component. The array of reflecting elements may be configured to receive control signal sets, where each control signal set configures the array of reflecting elements into a reflecting configuration having a plurality of subsets of the reflecting elements. Here, each subset of the plurality of subsets is configured to reflect radio frequency (RF) signals in a respective direction different from other ones of the first plurality of subsets. The reflecting configuration may define, for example, a block-wise configuration, and interlaced configuration, or a hybrid configuration of the plurality of subsets. Other aspects, embodiments, and features are also claimed and described.

### TECHNICAL FIELD

The technology discussed below relates generally to wireless communication systems, and more particularly, controllable reflective surfaces (e.g., reconfigurable intelligent surfaces (RIS)) that reflect in multiple directions simultaneously.

### INTRODUCTION

Wireless communication systems may include base stations, user equipment (UEs), among other devices that communicate over a wireless network. The communication range of base stations, UEs, and other network devices in the wireless network may define a network coverage area. Within the coverage area, UEs and base stations may wirelessly communicate with one another.

As the demand for mobile broadband access continues to increase, research and development continue to advance wireless communication technologies not only to meet the growing demand for mobile broadband access, but to advance and enhance the user experience with mobile communications. For example, significant interest has been directed to mechanisms and techniques for extending a network's coverage area.

### BRIEF SUMMARY OF SOME EXAMPLES

The following presents a simplified summary of one or more aspects of the present disclosure, to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In wireless communication systems, a network coverage area may be limited, for example, by design characteristics of a base station or obstacles in the base station's proximity. A UE that is outside the coverage area may be in a coverage dead zone and not able to communicate with the base station. A network operator may add a further base station to the network to provide network coverage for the UE. However, adding a base station to expand coverage of a network may result in a significant increase in expenses and, due to their active electronic components, a significant increase in power consumption. Accordingly, to expand network coverage with reduced power consumption and expense, a controllable reflective surface may be used. A controllable reflective surface may also be referred to as a reconfigurable intelligent surface (RIS), an intelligent reflecting surface (IRS), a large intelligent surface (LIS), a software-controlled metasurface, or any other suitable terminology. By reflecting signals, the controllable reflective surface may expand communication coverage and/or create additional propagation paths for a base station. However, even with a controllable reflective surface, coverage limitations and dead zones may exist.

To further expand coverage area for a network, this disclosure provides and enables controllable reflective surfaces that may be configured to reflect signals in multiple directions simultaneously. The configuration of a controllable reflective surface and, therefore, its multiple reflection directions, may be dynamically controlled. Further, the controllable reflective surface may be configured with multiple types of configurations to provide the multiple reflection directions. In some examples, a base station may send configuration information that partitions the controllable reflective surface into multiple subsets of reflecting elements, and/or that indicates a respective reflection direction for each subset.

In one example, a controllable reflective surface for wireless communication is provided. The controllable reflective surface includes an array of reflecting elements, each reflecting element comprising a radiating component and a phase-shifting component. The array of reflecting elements is configured to receive a first control signal set that configures the array of reflecting elements into a first reflecting configuration having a first plurality of subsets of the reflecting elements, each subset of the first plurality of subsets configured to reflect radio frequency (RF) signals in a respective direction different from other ones of the first plurality of subsets. The array of reflecting elements is further configured to receive a second control signal set that configures the array of reflecting elements into a second reflecting configuration having a second plurality of subsets of the reflecting elements, each subset of the second plurality of subsets configured to reflect RF signals in a respective direction different from other ones of the second plurality of subsets.

In another example, a controller for a controllable reflective surface is provided. The controller includes a processor, a communication interface communicatively coupled to the processor, a panel interface communicatively coupled to the processor, and a memory communicatively coupled to the processor. The controller is configured to receive, with the communication interface, first configuration information for reflecting elements of an array. The controller is further configured to send, with the panel interface, a first configuration control signal set, based on the first configuration information, indicating a first reflecting configuration for the array, the first reflecting configuration having a first plurality of subsets of the reflecting elements, each subset of the first plurality of subsets configured to reflect radio frequency (RF) signals in a respective direction different from other ones of the first plurality of subsets. The controller is further configured to receive, with the communication interface, second configuration information for the reflecting elements of the array. The controller is further configured to send, with the panel interface, a second configuration control signal set, based on the second configuration information, indicating a second reflecting configuration for the array, the second reflecting configuration having a second plurality of subsets of the reflecting elements, each subset of the second plurality of subsets configured to reflect RF signals in a respective direction different from other ones of the second plurality of subsets.

In another example, an apparatus for wireless communication is provided. The apparatus includes a processor, a communication interface communicatively coupled to the processor, and a memory communicatively coupled to the processor. The apparatus is configured to transmit, with the communication interface, first configuration information for reflecting elements of an array, wherein the first configuration information indicates a first reflecting configuration for the array, the first reflecting configuration having a first plurality of subsets of the reflecting elements, each subset of the first plurality of subsets configured to reflect radio frequency (RF) signals in a respective direction different from other ones of the first plurality of subsets. The apparatus is further configured to transmit, with the communication interface, second configuration information for the reflecting elements of the array, wherein the second configuration information indicates a second reflecting configuration for the array, the second reflecting configuration having a second plurality of subsets of the reflecting elements, each subset of the second plurality of subsets configured to reflect RF signals in a respective direction different from other ones of the second plurality of subsets.

In another example, a method for wireless communication is provided. The method includes receiving first configuration information for reflecting elements of an array. The method further includes sending a first configuration control signal set, based on the first configuration information, indicating a first reflecting configuration for the array, the first reflecting configuration having a first plurality of subsets of the reflecting elements, each subset of the first plurality of subsets configured to reflect radio frequency (RF) signals in a respective direction different from other ones of the first plurality of subsets. The method further includes receiving second configuration information for the reflecting elements of the array. The method further includes sending a second configuration control signal set, based on the second configuration information, indicating a second reflecting configuration for the array, the second reflecting configuration having a second plurality of subsets of the reflecting elements, each subset of the second plurality of subsets configured to reflect RF signals in a respective direction different from other ones of the second plurality of subsets.

These and other aspects of the technology discussed herein will become more fully understood upon a review of the detailed description, which follows. Other aspects, features, and embodiments will become apparent to those of ordinary skill in the art upon reviewing the following description of specific, exemplary embodiments in conjunction with the accompanying figures. While the following description may discuss various advantages and features relative to certain embodiments and figures, all embodiments can include one or more of the advantageous features discussed herein. In other words, while this description may discuss one or more embodiments as having certain advantageous features, one or more of such features may also be used in accordance with the various embodiments discussed herein. In similar fashion, while this description may discuss exemplary embodiments as device, system, or method embodiments, it should be understood that such exemplary embodiments can be implemented in various devices, systems, and methods.

### BRIEF DESCRIPTION OF THE DRAWINGS

FIG. 1 is a schematic illustration of a wireless communication system according to some embodiments.

FIG. 2 is a conceptual illustration of an example of a radio access network according to some embodiments.

FIG. 3 is a block diagram illustrating a wireless communication system supporting multiple-input multiple-output (MIMO) communication according to some embodiments.

FIG. 4 is a schematic illustration of an organization of wireless resources in an air interface utilizing orthogonal frequency divisional multiplexing (OFDM) according to some embodiments.

FIGS. 5A-B include schematic illustrations of wireless communication systems according to some embodiments.

FIG. 6 is a block diagram conceptually illustrating an example of a hardware implementation for a scheduling entity according to some embodiments.

FIG. 7 is a block diagram conceptually illustrating an example of a hardware implementation for a controllable reflective surface according to some embodiments.

FIG. 8 is illustrates a diagram of an example of a controllable reflective surface according to some embodiments.

FIG. 9 is a flow chart illustrating an exemplary process for a controller to configure a controllable reflective surface according to some embodiments.

FIG. 10 is a flow chart illustrating an exemplary process for configuring a controllable reflective surface according to some embodiments.

FIG. 11 is a flow chart illustrating an exemplary process for a scheduling entity to configure a controllable reflective surface according to some embodiments.

FIG. 12A illustrates an exemplary block-wise configuration for a controllable reflective surface according to some embodiments.

FIG. 12B illustrates an exemplary interlaced configuration for a controllable reflective surface according to some embodiments.

FIG. 13A illustrates an exemplary block-wise configuration for a controllable reflective surface according to some embodiments.

FIG. 13B illustrates an exemplary interlaced configuration for a controllable reflective surface according to some embodiments.

FIG. 14A illustrates an exemplary hybrid configuration for a controllable reflective surface according to some embodiments.

FIG. 14B illustrates another exemplary hybrid configuration for a controllable reflective surface according to some embodiments.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, those skilled in the art will readily recognize that these concepts may be practiced without these specific details. In some instances, this description provides well known structures and components in block diagram form in order to avoid obscuring such concepts.

While this description describes aspects and embodiments by illustration to some examples, those skilled in the art will understand that additional implementations and use cases may come about in many different arrangements and scenarios. Innovations described herein may be implemented across many differing platform types, devices, systems, shapes, sizes, packaging arrangements, etc. For example, embodiments and/or uses may come about via integrated chip (IC) embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may span over a spectrum from chip-level or modular components to non-modular, non-chip-level implementations and further to aggregate, distributed, or original equipment manufacturer (OEM) devices or systems incorporating one or more aspects of the disclosed technology. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, radio frequency (RF) chains, power amplifiers, modulators, buffer, processor(s), interleaver, adders/summers, etc.). It is intended that the disclosed technology may be practiced in a wide variety of devices, chip-level components, systems, distributed arrangements, aggregated devices, disaggregated arrangements, end-user devices, etc. of varying sizes, shapes, and constitution.

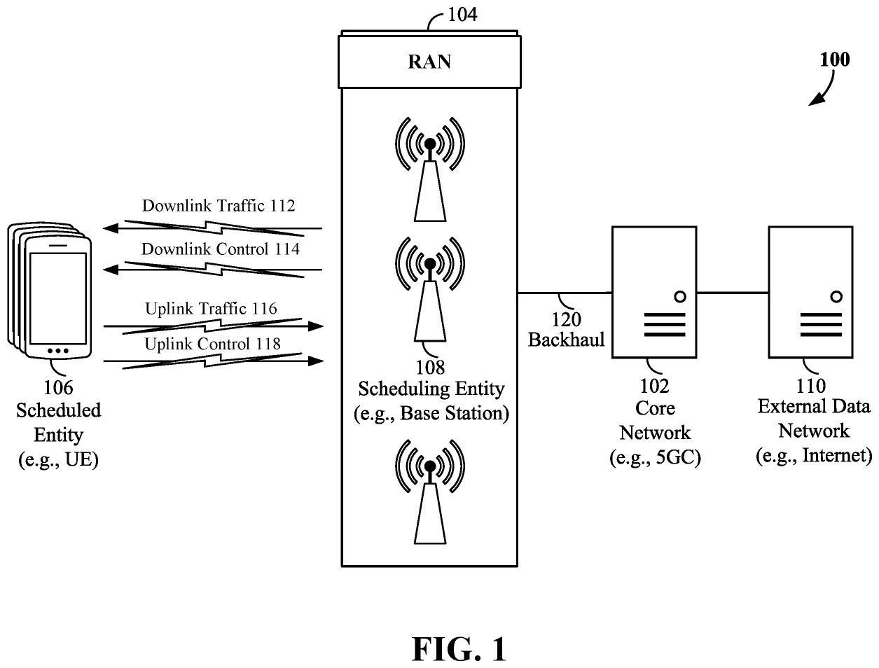

The disclosure that follows presents various concepts that may be implemented across a broad variety of telecommunication systems, network architectures, and communication standards. Referring now to FIG. 1, as an illustrative example without limitation, this schematic illustration shows various aspects of the present disclosure with reference to a wireless communication system 100. The wireless communication system 100 includes several interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3rd Generation Partnership Project (3GPP) New Radio (NR) specifications, often referred to as 5G or 5G NR. In some examples, the RAN 104 may operate under a hybrid of 5G NR and Evolved Universal Terrestrial Radio Access Network (eUTRAN) standards, often referred to as Long-Term Evolution (LTE). 3GPP refers to this hybrid RAN as a next-generation RAN, or NG-RAN. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, those skilled in the art may variously refer to a “base station” as a base transceiver station (BTS), a radio base station, a radio transceiver, a transceiver function, a basic service set (BSS), an extended service set (ESS), an access point (AP), a Node B (NB), an eNode B (eNB), a gNode B (gNB), or some other suitable terminology.

The RAN 104 supports wireless communication for multiple mobile apparatuses. Those skilled in the art may refer to a mobile apparatus as a UE, as in 3GPP specifications, but may also refer to a mobile apparatus (or a UE) as a mobile station (MS), a subscriber station, a mobile unit, a subscriber unit, a wireless unit, a remote unit, a mobile device, a wireless device, a wireless communication device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides access to network services. A UE may take on many forms and can include a range of devices.

Within the present document, a “mobile” apparatus (aka a UE) need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc.; an industrial automation and enterprise device; a logistics controller; agricultural equipment; military defense equipment, vehicles, aircraft, ships, and weaponry, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between a RAN 104 and a UE 106 may be described as utilizing an air interface. Transmissions over the air interface from a base station (e.g., base station 108) to one or more UEs (e.g., UE 106) may be referred to as downlink (DL) transmission. In accordance with certain aspects of the present disclosure, the term downlink may refer to a point-to-multipoint transmission originating at a scheduling entity (described further below; e.g., base station 108). Another way to describe this scheme may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a scheduled entity (described further below; e.g., UE 106).

In some examples, access to the air interface may be scheduled. In some deployments, for example, a scheduling entity (e.g., a base station 108) allocates resources for communication among some or all devices and equipment within its service area or cell. A scheduling entity may be responsible for scheduling, assigning, reconfiguring, and releasing resources for one or more scheduled entities. That is, for scheduled communication, UEs 106, which may be scheduled entities, may utilize resources allocated by the scheduling entity 108.

Base stations 108 are not the only entities that may function as scheduling entities. That is, in some examples, a UE may function as a scheduling entity, scheduling resources for one or more scheduled entities (e.g., one or more other UEs). Other devices may also perform scheduling operations or aid in facilitating scheduling operations.

As illustrated in FIG. 1, a scheduling entity 108 may broadcast downlink traffic 112 to one or more scheduled entities 106. Broadly, the scheduling entity 108 is a node or device responsible for scheduling traffic in a wireless communication network, including the downlink traffic 112 and, in some examples, uplink traffic 116 from one or more scheduled entities 106 to the scheduling entity 108. On the other hand, the scheduled entity 106 is a node or device that receives downlink control information 114, including but not limited to scheduling information (e.g., a grant), synchronization or timing information, or other control information from another entity in the wireless communication network such as the scheduling entity 108.

In general, base stations 108 may include a backhaul interface for communication with a backhaul portion 120 of the wireless communication system. The backhaul 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

In some examples, the RAN 104 has an open radio access network (O-RAN) architecture. In such examples, the RAN 104 may include (or be disaggregated into) one or more centralized units (CUs), one or more distributed units (DUs), and one or more radio units (RUs) that serve as the scheduling entities 108. In other words, the functionality of the respective scheduling entities 108 of the RAN 104 are split among one or more a CU, a DU, and an RU. Accordingly, in an O-RAN architecture, the scheduling entity 108 of the RAN 104 may include or refer to one or more of a CU, a DU, and an RU. A CU may be communicatively coupled to the core network 102 via a backhaul (e.g., the backhaul 120) and to one or more DUs via respective midhaul connections. The CU and each DU may collectively perform a substantial portion of the computations of a gNB or base station. In some examples, the CU and DUs may be physically separated from one another. Each DU may be connected to an RU via a fronthaul connection. In some examples, the DU and RU and may be located at a same or nearby location. An RU may transmit and receive radio frequency signals with scheduled entities 106 (e.g., UEs) via an integrated or nearby antenna. For example, an RU may digitize radio signals (e.g., uplink traffic 116 and/or uplink control 118) received via an antenna and provide the digitized signals to an associated DU. Further, the RU may transmit, via the antenna, digital signals received from the associated DU as radio frequency signals (e.g., downlink traffic 112 and/or downlink control 114).

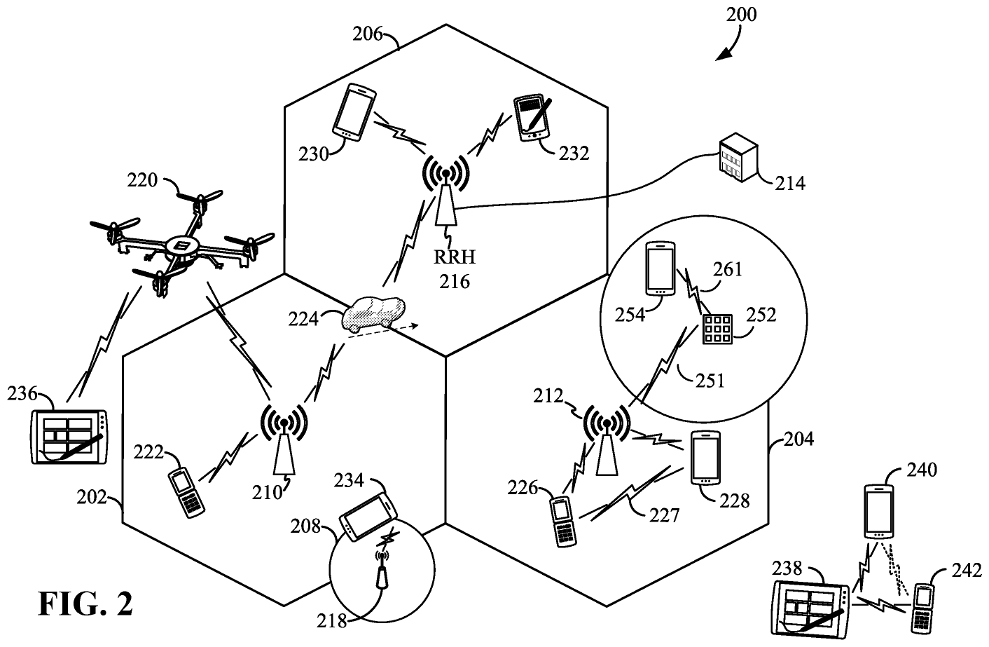

FIG. 2 provides a schematic illustration of a RAN 200, by way of example and without limitation. In some examples, the RAN 200 may be the same as the RAN 104 described above and illustrated in FIG. 1. The geographic area covered by the RAN 200 may be divided into cellular regions (cells) that a user equipment (UE) can uniquely identify based on an identification broadcasted from one access point or base station. FIG. 2 illustrates macrocells 202, 204, and 206, and a small cell 208, each of which may include one or more sectors (not shown). A sector is a sub-area of a cell. All sectors within one cell may be served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

FIG. 2 shows two base stations 210 and 212 in cells 202 and 204; and shows a third base station 214 controlling a remote radio head (RRH) 216 in cell 206. That is, a base station can have an integrated antenna or can be connected to an antenna or RRH by feeder cables. In the illustrated example, the cells 202, 204, and 206 may be referred to as macrocells, as the base stations 210, 212, and 214 support cells having a large size. Further, a base station 218 is shown in the small cell 208 (e.g., a microcell, picocell, femtocell, home base station, home Node B, home eNode B, etc.) which may overlap with one or more macrocells. In this example, the cell 208 may be referred to as a small cell, as the base station 218 supports a cell having a relatively small size. Cell sizing can be done according to system design as well as component constraints.

The RAN 200 may include any number of wireless base stations and cells. Further, a RAN may include a relay node to extend the size or coverage area of a given cell. The base stations 210, 212, 214, 218 provide wireless access points to a core network for any number of mobile apparatuses. In some examples, the base stations 210, 212, 214, and/or 218 may be the same as the base station/scheduling entity 108 described above and illustrated in FIG. 1.

FIG. 2 further includes a quadcopter or drone 220, which may be configured to function as a base station. That is, in some examples, a cell may not necessarily be stationary, and the geographic area of the cell may move according to the location of a mobile base station such as the quadcopter 220.

Within the RAN 200, the cells may include UEs that may be in communication with one or more sectors of each cell. Further, each base station 210, 212, 214, 218, and 220 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; UE 234 may be in communication with base station 218; and UE 236 may be in communication with mobile base station 220. In some examples, the UEs 222, 224, 226, 228, 230, 232, 234, 236, 238, 240, and/or 242 may be the same as the UE/scheduled entity 106 described above and illustrated in FIG. 1.

In some examples, a mobile network node (e.g., quadcopter 220) may be configured to function as a UE. For example, the quadcopter 220 may operate within cell 202 by communicating with base station 210.

In a further aspect of the RAN 200, sidelink signals may be used between UEs without necessarily relying on scheduling or control information from a base station. For example, two or more UEs (e.g., UEs 226 and 228) may communicate with each other using peer to peer (P2P) or sidelink signals 227 without relaying that communication through a base station (e.g., base station 212). In a further example, UE 238 is illustrated communicating with UEs 240 and 242. Here, the UE 238 may function as a scheduling entity or a primary sidelink device, and UEs 240 and 242 may function as a scheduled entity or a non-primary (e.g., secondary) sidelink device. In still another example, a UE may function as a scheduling entity in a device-to-device (D2D), peer-to-peer (P2P), or vehicle-to-vehicle (V2V) network, and/or in a mesh network. In a mesh network example, UEs 240 and 242 may optionally communicate directly with one another in addition to communicating with the scheduling entity 238. Thus, in a wireless communication system with scheduled access to time-frequency resources and having a cellular configuration, a P2P configuration, or a mesh configuration, a scheduling entity and one or more scheduled entities may communicate utilizing the scheduled resources.

In FIG. 2, a controllable reflective surface 252 may be deployed to extend the size or coverage area of a given cell. The controllable reflective surface 252 may be within the cell 204 of the base station 212. The base station 212 may transmit signals 251 to the controllable reflective surface 252. The controllable reflective surface 252 may redirect the signals 251 as signals 261 to a UE 254. Similarly, the UE 254 may transmit signals 261 to the controllable reflective surface 252, and the controllable reflective surface 252 may redirect the signals 261 as signals 251 to the base station 212. Accordingly, the controllable reflective surface 252 may reflect uplink and downlink signals. The controllable reflective surface 252 may enable communication between the UE 254 and the base station 212 in instances where such communication may otherwise be prevented or have degraded quality. For example, the controllable reflective surface 252 may enable communication between the UE 254 and the base station 212 when an obstacle is blocking direct signals between the devices. Additionally or alternatively, the controllable reflective surface 252 may enable communication between the UE 254 and the base station 212 when one or both of the devices is transmitting a directional beam in a direction away from or not towards the other device. In some examples, communications between the base station 212 and UE 254 are redirected by a string of more than one controllable reflective surface.

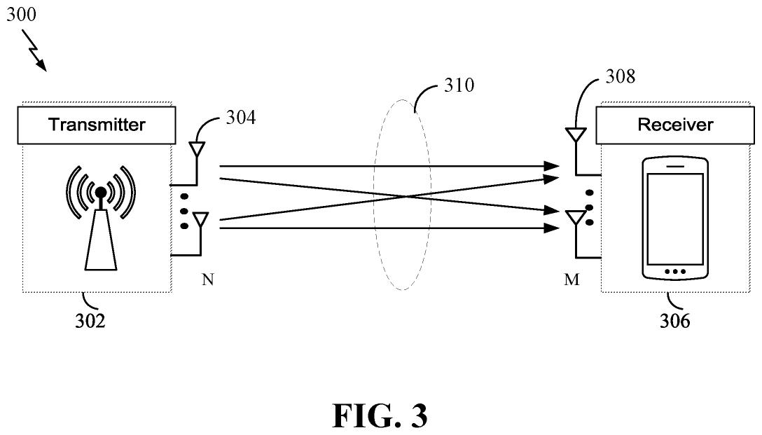

In some aspects of the disclosure, a scheduling entity, scheduled entity, and/or controllable reflective surface may be configured with multiple antennas for beamforming and/or multiple-input multiple-output (MIMO) technology. FIG. 3 illustrates an example of a wireless communication system 300 with multiple antennas, supporting beamforming and/or MIMO. The use of such multiple antenna technology enables the wireless communication system to exploit the spatial domain to support spatial multiplexing, beamforming, and transmit diversity.

Beamforming generally refers to directional signal transmission or reception. For a beamformed transmission, a transmitting device may precode, or control the amplitude and phase of each antenna in an array of antennas to create a desired (e.g., directional) pattern of constructive and destructive interference in the wavefront. In a MIMO system, a transmitter 302 includes multiple transmit antennas 304 (e.g., N transmit antennas) and a receiver 306 includes multiple receive antennas 308 (e.g., M receive antennas). Thus, there are N×M signal paths 310 from the transmit antennas 304 to the receive antennas 308. Each of the transmitter 302 and the receiver 306 may be implemented, for example, within a scheduling entity 108, a scheduled entity 106, or any other suitable wireless communication device.

In a MIMO system, spatial multiplexing may be used to transmit multiple different streams of data, also referred to as layers, simultaneously on the same time-frequency resource. In some examples, a transmitter 302 may send multiple data streams to a single receiver. In this way, a MIMO system takes advantage of capacity gains and/or increased data rates associated with using multiple antennas in rich scattering environments where channel variations can be tracked. Here, the receiver 306 may track these channel variations and provide corresponding feedback to the transmitter 302. In one example case, as shown in FIG. 3, a rank-2 (i.e., including 2 data streams) spatial multiplexing transmission on a 2×2 MIMO antenna configuration will transmit two data streams via two transmit antennas 304. The signal from each transmit antenna 304 reaches each receive antenna 308 along a different signal path 310. The receiver 306 may then reconstruct the data streams using the received signals from each receive antenna 308.

In some examples, a transmitter may send multiple data streams to multiple receivers. This is generally referred to as multi-user MIMO (MU-MIMO). In this way, a MU-MIMO system exploits multipath signal propagation to increase the overall network capacity by increasing throughput and spectral efficiency, and reducing the required transmission energy. This is achieved by a transmitter 302 spatially precoding (i.e., multiplying the data streams with different weighting and phase shifting) each data stream (in some examples, based on known channel state information) and then transmitting each spatially precoded stream through multiple transmit antennas to the receiving devices using the same allocated time-frequency resources. A receiver (e.g., receiver 306) may transmit feedback including a quantized version of the channel so that the transmitter 302 can schedule the receivers with good channel separation. The spatially precoded data streams arrive at the receivers with different spatial signatures, which enables the receiver(s) (in some examples, in combination with known channel state information) to separate these streams from one another and recover the data streams destined for that receiver. In the other direction, multiple transmitters can each transmit a spatially precoded data stream to a single receiver, which enables the receiver to identify the source of each spatially precoded data stream.

The number of data streams or layers in a MIMO or MU-MIMO (generally referred to as MIMO) system corresponds to the rank of the transmission. In general, the rank of a MIMO system is limited by the number of transmit or receive antennas 304 or 308, whichever is lower. In addition, the channel conditions at the receiver 306, as well as other considerations, such as the available resources at the transmitter 302, may also affect the transmission rank. For example, a base station in a RAN (e.g., transmitter 302) may assign a rank (and therefore, a number of data streams) for a DL transmission to a particular UE (e.g., receiver 306) based on a rank indicator (RI) the UE transmits to the base station. The UE may determine this RI based on the antenna configuration (e.g., the number of transmit and receive antennas) and a measured signal-to-interference-and-noise ratio (SINR) on each of the receive antennas. The RI may indicate, for example, the number of layers that the UE may support under the current channel conditions. The base station may use the RI along with resource information (e.g., the available resources and amount of data to be scheduled for the UE) to assign a DL transmission rank to the UE.

The transmitter 302 determines the precoding of the transmitted data stream or streams based, e.g., on known channel state information of the channel on which the transmitter 302 transmits the data stream(s). For example, the transmitter 302 may transmit one or more suitable reference signals (e.g., a channel state information reference signal, or CSI-RS) that the receiver 306 may measure. The receiver 306 may then report measured channel quality information (CQI) back to the transmitter 302. This CQI generally reports the current communication channel quality, and in some examples, a requested transport block size (TBS) for future transmissions to the receiver. In some examples, the receiver 306 may further report a precoding matrix indicator (PMI) to the transmitter 302. This PMI generally reports the receiver's 306 preferred precoding matrix for the transmitter 302 to use, and may be indexed to a predefined codebook. The transmitter 302 may then utilize this CQI/PMI to determine a suitable precoding matrix for transmissions to the receiver 306.

In Time Division Duplex (TDD) systems, the UL and DL may be reciprocal, in that each uses different time slots of the same frequency bandwidth. Therefore, in TDD systems, a transmitter 302 may assign a rank for DL MIMO transmissions based on an UL SINR measurement (e.g., based on a sounding reference signal (SRS) or other pilot signal transmitted from the receiver 306). Based on the assigned rank, the transmitter 302 may then transmit a channel state information reference signal (CSI-RS) with separate sequences for each layer to provide for multi-layer channel estimation. From the CSI-RS, the receiver 306 may measure the channel quality across layers and resource blocks. The receiver 306 may then transmit a CSI report (including, e.g., CQI, RI, and PMI) to the transmitter 302 for use in updating the rank and assigning resources for future DL transmissions.

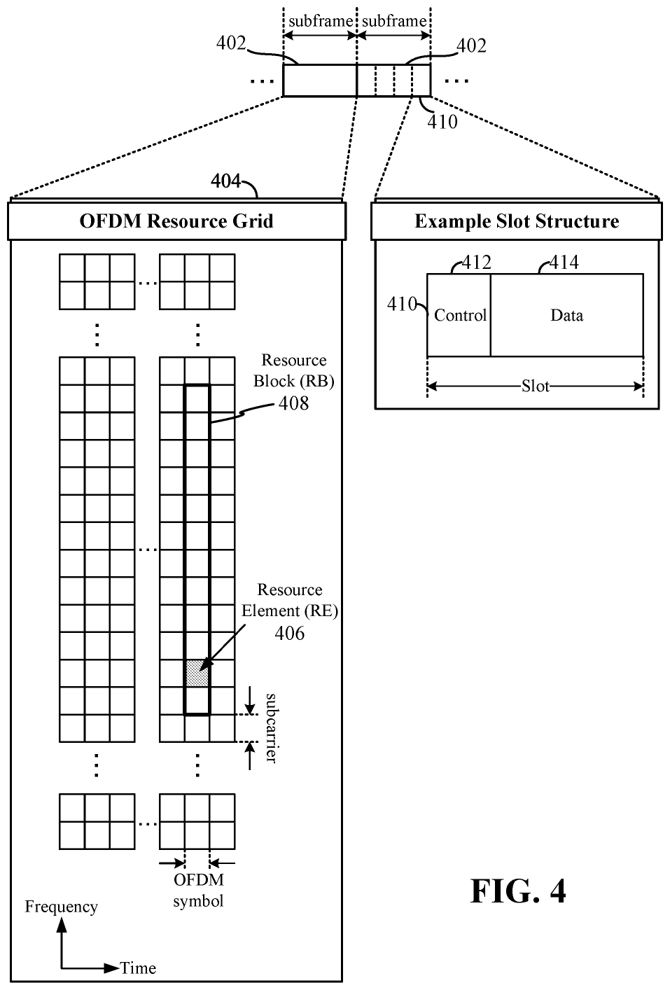

FIG. 4 schematically illustrates various aspects of the present disclosure with reference to an OFDM waveform. Those of ordinary skill in the art should understand that the various aspects of the present disclosure may be applied to a DFT-s-OFDMA waveform in substantially the same way as described herein below. That is, while some examples of the present disclosure may focus on an OFDM link for clarity, it should be understood that the same principles may be applied as well to DFT-s-OFDMA waveforms.

In some examples, a frame may refer to a predetermined duration of time (e.g., 10 ms) for wireless transmissions. And further, each frame may consist of a set of subframes (e.g., 10 subframes of 1 ms each). A given carrier may include one set of frames in the UL, and another set of frames in the DL. FIG. 4 illustrates an expanded view of an exemplary DL subframe 402, showing an OFDM resource grid 404. However, as those skilled in the art will readily appreciate, the PHY transmission structure for any particular application may vary from the example described here, depending on any number of factors. Here, time is illustrated in the horizontal direction with units of OFDM symbols; and frequency is illustrated in the vertical direction with units of subcarriers or tones.

The resource grid 404 may schematically represent time-frequency resources for a given antenna port. That is, in a MIMO implementation with multiple antenna ports available, a corresponding multiple number of resource grids 404 may be available for communication. The resource grid 404 is divided into multiple resource elements (REs) 406. An RE, which is 1 subcarrier×1 symbol, is the smallest discrete part of the time-frequency grid, and may contain a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 408, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. The present disclosure assumes, by way of example, that a single RB such as the RB 408 entirely corresponds to a single direction of communication (either transmission or reception for a given device).

A UE generally utilizes only a subset of the resource grid 404. An RB may be the smallest unit of resources that a scheduler can allocate to a UE. Thus, the more RBs scheduled for a UE, and the higher the modulation scheme chosen for the air interface, the higher the data rate for the UE.

In this illustration, the RB 408 occupies less than the entire bandwidth of the subframe 402, with some subcarriers illustrated above and below the RB 408. In a given implementation, the subframe 402 may have a bandwidth corresponding to any number of one or more RBs 408. Further, the RB 408 is shown occupying less than the entire duration of the subframe 402, although this is merely one possible example.

In some deployments, each 1 ms subframe 402 (e.g., a 1 ms subframe) may consist of one or multiple adjacent slots. In FIG. 4, one subframe 402 includes four slots 410, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots having a shorter duration (e.g., one or two OFDM symbols). A base station may in some cases transmit these mini-slots occupying resources scheduled for ongoing slot transmissions for the same or for different UEs.

An expanded view of one of the slots 410 illustrates the slot 410 including a control region 412 and a data region 414. In general, the control region 412 may carry control channels (e.g., PDCCH), and the data region 414 may carry data channels (e.g., PDSCH or PUSCH). Of course, a slot may contain all DL, all UL, or at least one DL portion and at least one UL portion. The structure illustrated in FIG. 4 is merely exemplary in nature, and different slot structures may be utilized, and may include one or more of the control region(s) and data region(s).

Although not illustrated in FIG. 4, various REs 406 within an RB 408 may carry one or more physical channels, including control channels, shared channels, data channels, etc. Other REs 406 within the RB 408 may also carry pilots or reference signals. These pilots or reference signals may provide for a receiving device to perform channel estimation of the corresponding channel, which may enable coherent demodulation/detection of the control and/or data channels within the RB 408.

In a DL transmission, a transmitting device (e.g., the scheduling entity 108) may allocate one or more REs 406 (e.g., within a control region 412) to carry one or more DL control channels. These DL control channels include DL control information 114 (DCI) that generally carries information originating from higher layers, such as a physical broadcast channel (PBCH), a physical downlink control channel (PDCCH), etc., to one or more scheduled entities 106. In addition, the transmitting device may allocate one or more DL REs to carry DL physical signals that generally do not carry information originating from higher layers. These DL physical signals may include a primary synchronization signal (PSS); a secondary synchronization signal (SSS); demodulation reference signals (DM-RS); phase-tracking reference signals (PT-RS); channel-state information reference signals (CSI-RS); etc.

A base station may transmit synchronization signals PSS and SSS (collectively referred to as SS), and in some examples, the PBCH, in an SS block that includes 4 consecutive OFDM symbols. The OFDM symbols may be numbered via a time index in increasing order from 0 to 3. In the frequency domain, the SS block may extend over 240 contiguous subcarriers, with the subcarriers being numbered via a frequency index in increasing order from 0 to 239. Of course, the present disclosure is not limited to this specific SS block configuration. Other nonlimiting examples may utilize greater or fewer than two synchronization signals; may include one or more supplemental channels in addition to the PBCH; may omit a PBCH; and/or may utilize nonconsecutive symbols for an SS block, within the scope of the present disclosure.

The PDCCH may carry downlink control information (DCI) for one or more UEs in a cell. This can include, but is not limited to, power control commands, scheduling information, a grant, and/or an assignment of REs for DL and UL transmissions.

In an UL transmission, a transmitting device (e.g., a scheduled entity 106) may utilize one or more REs 406 to carry one or more UL control channels, such as a physical uplink control channel (PUCCH), a physical random access channel (PRACH), etc. These UL control channels include UL control information 118 (UCI) that generally carries information originating from higher layers. Further, UL REs may carry UL physical signals that generally do not carry information originating from higher layers, such as demodulation reference signals (DM-RS), phase-tracking reference signals (PT-RS), sounding reference signals (SRS), etc. In some examples, the control information 118 may include a scheduling request (SR), i.e., a request for the scheduling entity 108 to schedule uplink transmissions. Here, in response to the SR transmitted on the control channel 118, the scheduling entity 108 may transmit downlink control information 114 that may schedule resources for uplink packet transmissions.

UL control information may also include hybrid automatic repeat request (HARQ) feedback such as an acknowledgment (ACK) or negative acknowledgment (NACK), channel state information (CSI), or any other suitable UL control information. HARQ is a technique well-known to those of ordinary skill in the art, wherein a receiving device can check the integrity of packet transmissions for accuracy, e.g., utilizing any suitable integrity checking mechanism, such as a checksum or a cyclic redundancy check (CRC). If the receiving device confirms the integrity of the transmission, it may transmit an ACK, whereas if not confirmed, it may transmit a NACK. In response to a NACK, the transmitting device may send a HARQ retransmission, which may implement chase combining, incremental redundancy, etc.

In addition to control information, one or more REs 406 (e.g., within the data region 414) may be allocated for user data or traffic data. Such traffic may be carried on one or more traffic channels, such as, for a DL transmission, a physical downlink shared channel (PDSCH); or for an UL transmission, a physical uplink shared channel (PUSCH).

In order for a UE to gain initial access to a cell, the RAN may provide system information (SI) characterizing the cell. The RAN may provide this system information utilizing minimum system information (MSI), and other system information (OSI). The RAN may periodically broadcast the MSI over the cell to provide the most basic information a UE requires for initial cell access, and for enabling a UE to acquire any OSI that the RAN may broadcast periodically or send on-demand. In some examples, a network may provide MSI over two different downlink channels. For example, the PBCH may carry a master information block (MIB), and the PDSCH may carry a system information block type 1 (SIB1). Here, the MIB may provide a UE with parameters for monitoring a control resource set. The control resource set may thereby provide the UE with scheduling information corresponding to the PDSCH, e.g., a resource location of SIB1. In the art, SIB1 may be referred to as remaining minimum system information (RMSI).

OSI may include any SI that is not broadcast in the MSI. In some examples, the PDSCH may carry a plurality of SIBs, not limited to SIB1, discussed above. Here, the RAN may provide the OSI in these SIBs, e.g., SIB2 and above.

The channels or carriers described above and illustrated in FIGS. 1 and 4 are not necessarily all the channels or carriers that may be utilized between a scheduling entity 108 and scheduled entities 106, and those of ordinary skill in the art will recognize that other channels or carriers may be utilized in addition to those illustrated, such as other traffic, control, and feedback channels.

In some examples, a physical layer may generally multiplex and map these physical channels described above to transport channels for handling at a medium access control (MAC) layer entity. Transport channels carry blocks of information called transport blocks (TB). The transport block size (TBS), which may correspond to a number of bits of information, may be a controlled parameter, based on the modulation and coding scheme (MCS) and the number of RBs in a given transmission.

In 5G NR, base stations incorporating massive multiple-input multiple-output (MIMO) antennas can play a role in increasing throughput. In some examples, these base stations achieve increased throughput by incorporating active antenna units (AAUs) with high beamforming gain and antenna ports that each may have an individual radio frequency transceiver chain. However, adding base stations with AAUs to expand coverage of a network may result in a significant increase in expenses and, due to their active electronic components, a significant increase in power consumption. Accordingly, to expand network coverage with reduced power consumption and expense, a controllable reflective surface may be used.

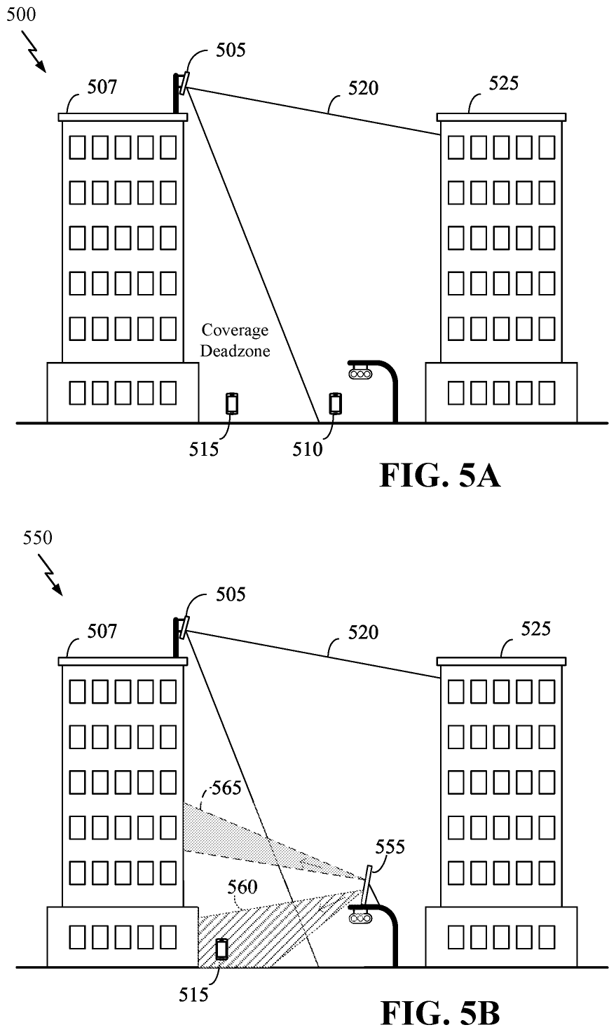

FIGS. 5A-B illustrate a communication system 500. The communication system 500 may be an example of a portion of the communication system 100 or the RAN 200. The communication system 500 may provide a 5G NR network and/or another communication network. In FIG. 5A, the communication system 500 includes a base station 505 positioned on a building 507, a first UE 510, and a second UE 515. The base station 505 has a coverage area 520 within which a UE, such as the second UE 515, can communicate with the base station 505. The coverage area 520 may be limited, for example, by design characteristics of the base station 505 or obstacles (e.g., the building 507). A UE that is outside of the coverage area 520, such as the first UE 510, may be in a coverage dead zone and not able to communicate with the base station 505.

A further base station, similar to the base station 505, could be added to the network (e.g., on a building 525) to provide network coverage for the UE 515. However, adding a base station to expand coverage of a network may result in a significant increase in expenses and, due to their active electronic components, a significant increase in power consumption. Accordingly, to expand network coverage with reduced power consumption and expense, a controllable reflective surface may be used.

FIG. 5B illustrates another example of a communication system 550. The communication system 550 may be similar to the communication system 500, but further includes a controllable reflective surface 555. Like numbers are used for elements of the communication system 550 that are similar to elements of the communication system 500. The controllable reflective surface 555 may be an example of the controllable reflective surface 252 of FIG. 2. By reflecting signals, the controllable reflective surface 555 may expand communication coverage and/or create additional propagation paths for a base station, such as the base station 505. For example, the controllable reflective surface 555 may reflect signals to provide extended coverage areas 560 and 565. To provide the extended coverage areas 560 and 565, the controllable reflective surface 555 may be configured to reflect signals from the base station 505 in two directions, as indicate by the directional arrows within the respective coverage areas 560 and 565. The controllable reflective surface 555 may similarly reflect signals from UEs within the respective coverage areas 560 and 565 to the base station 505. Accordingly, the controllable reflective surface 555 provides the UE 510 access to the base station 505 despite the UE 510 being outside of the coverage area 520 (and in the area of the coverage dead zone of FIG. 5A). In other examples, the controllable reflective surface 555 is configured to reflect signals in a different number of directions, such as one direction, three directions, four directions, etc. By reflecting signals in multiple (diverse) directions simultaneously, a controllable reflective surface may extend coverage through spatial diversity. Techniques and systems for configuring a controllable reflective surface, such as the controllable reflective surface 555, to reflect signals in one or more directions are provided below.

The controllable reflective surface 555 may also be referred to as a reconfigurable intelligent surface (RIS), an intelligent reflecting surface (IRS), a large intelligent surface (LIS), a software-controlled metasurface, or any other suitable terminology. In some examples, the controllable reflective surface 555 is a passive panel in that power is not supplied to boost signal propagation. In other words, the controllable reflective surface 555 may reflect an incoming signal without increasing the propagation power of the signal through powered amplification. Such examples may also be referred to as a passive controllable reflective surface or passive multiple input multiple output (MIMO) panel. In some examples, the controllable reflective surface 555 is an active panel, in which case, power may be used to amplify or boost propagation power of a reflected signal. Such examples may also be referred to as an active controllable reflective surface or active MIMO panel.

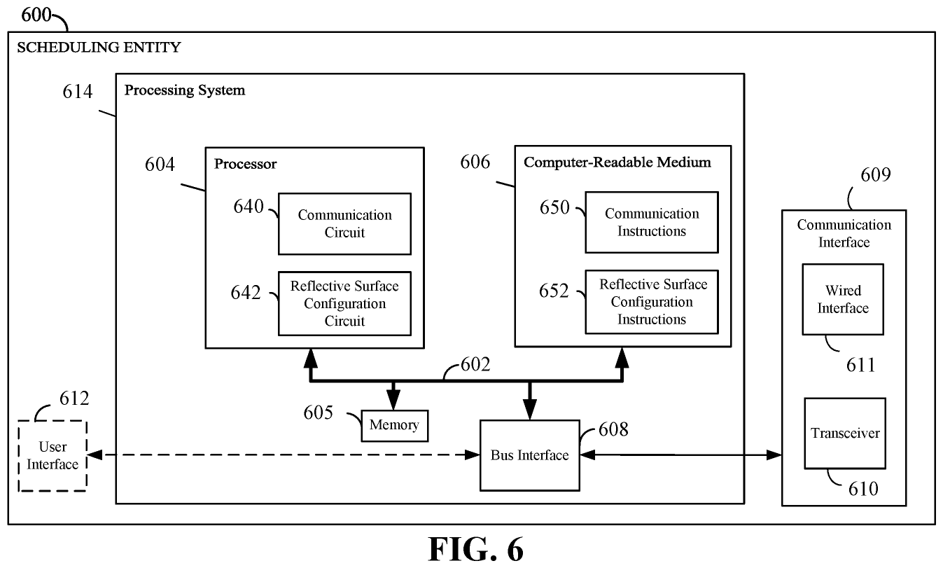

FIG. 6 is a block diagram illustrating an example of a hardware implementation for a scheduling entity 600 employing a processing system 614. For example, the scheduling entity 600 may be a base station as illustrated in any one or more of FIGS. 1, 2, 3, 5A, and/or 5B. In another example, the scheduling entity 600 may be a user equipment (UE) as illustrated in any one or more of FIGS. 1, 2, 3, 5A, and/or 5B.

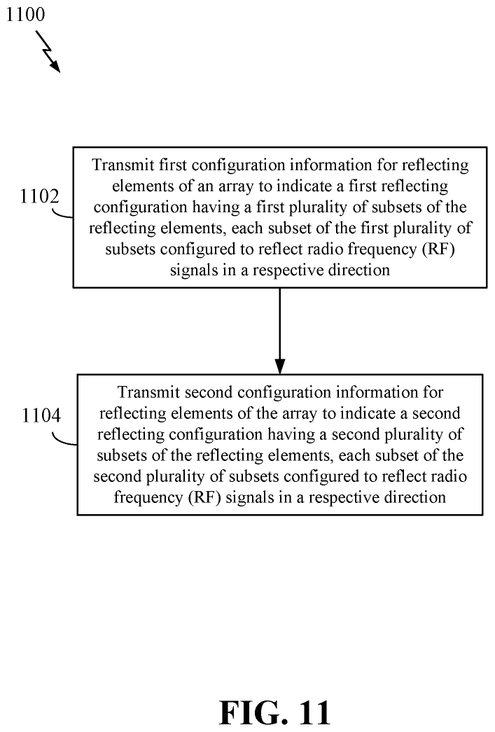

The scheduling entity 600 may include a processing system 614 having one or more processors 604. Examples of processors 604 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the scheduling entity 600 may be configured to perform any one or more of the functions described herein. That is, the processor 604, as utilized in a scheduling entity 600, may be configured (e.g., in coordination with the memory 605) to implement any one or more of the processes and procedures described below and illustrated in FIG. 11.

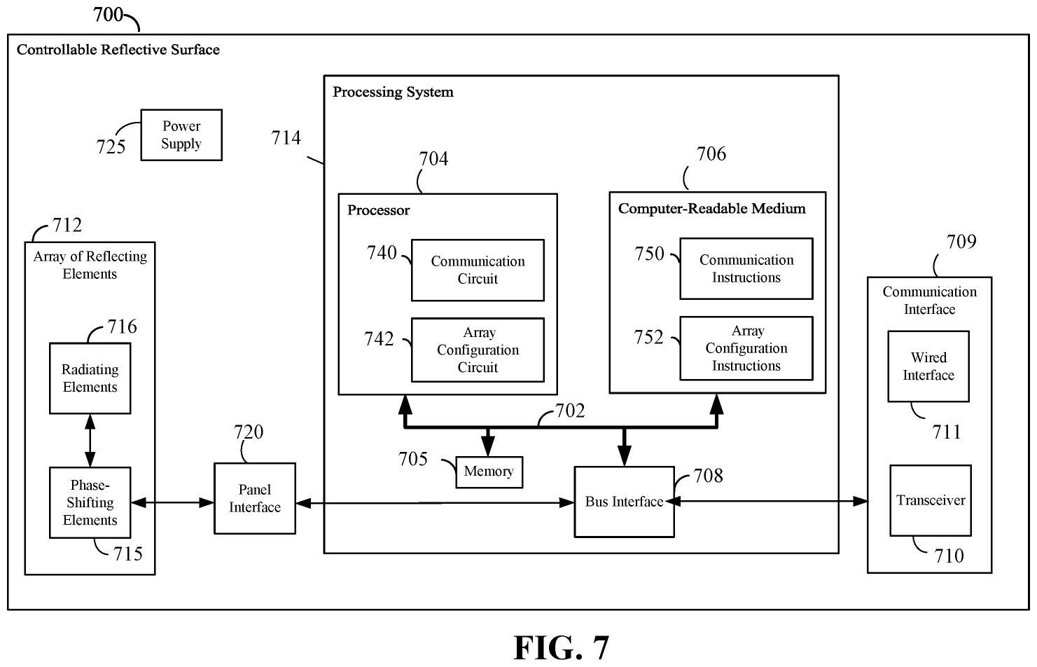

The processing system 614 may be implemented with a bus architecture, represented generally by the bus 602. The bus 602 may include any number of interconnecting buses and bridges depending on the specific application of the processing system 614 and the overall design constraints. The bus 602 communicatively couples together various circuits including one or more processors (represented generally by the processor 604), a memory 605, and computer-readable media (represented generally by the computer-readable medium 606). The bus 602 may also link various other circuits such as timing sources, peripherals, voltage regulators, and power management circuits, which are well known in the art, and therefore, will not be described any further. A bus interface 608 provides an interface between the bus 602 and a communication interface 609. The communication interface 609 may include one or both of a transceiver 610 and a wired interface 611. The transceiver 610 provides a communication interface or means for communicating with various other apparatus over a transmission medium. For example, the scheduling entity 600 may wirelessly communicate with a scheduled entity (e.g., a UE) and/or a controllable reflective surface (see, e.g., a controllable reflective surface 700 of FIG. 7). In some examples, in addition to or instead of communicating with a controllable reflective surface via the transceiver 610, the scheduling entity 600 communicates with the controllable reflective surface via the wired interface 611. The wired interface 611 may provide a wired connection to the controllable reflective surface. Depending upon the nature of the apparatus, a user interface 612 (e.g., keypad, display, speaker, microphone, joystick) may also be provided. Of course, such a user interface 612 is optional, and some examples, such as a base station, may omit it.

In some aspects of the disclosure, the processor 604 may include communication circuitry 640 configured (e.g., in coordination with the memory 605) for various functions, including, e.g., communicating with UEs, communicating with controllable reflective surfaces, transmitting configuration information to controllable reflective surfaces. For example, the communication circuitry 640 may be configured to implement one or more of the functions described below in relation to FIG. 11, including, e.g., blocks 1102 and/or 1104. In some aspects of the disclosure, the processor 604 may further include reflective surface configuration circuitry 642 configured (e.g., in coordination with the memory 605) for various functions, including, e.g., determining and/or generating configuration information for controllable reflective surfaces. For example, the communication circuitry 640 may be configured to implement one or more of the functions described below in relation to FIG. 11, including, e.g., blocks 1102 and/or 1104.

The processor 604 is responsible for managing the bus 602 and general processing, including the execution of software stored on the computer-readable medium 606. The software, when executed by the processor 604, causes the processing system 614 to perform the various functions described below for any particular apparatus. The processor 604 may also use the computer-readable medium 606 and the memory 605 for storing data that the processor 604 manipulates when executing software.

One or more processors 604 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 606. The computer-readable medium 606 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 606 may reside in the processing system 614, external to the processing system 614, or distributed across multiple entities including the processing system 614. The computer-readable medium 606 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In one or more examples, the computer-readable storage medium 606 may store computer-executable code that includes communication instructions 650 that configure a scheduling entity 600 for various functions, including, e.g., communicating with UEs, communicating with controllable reflective surfaces, transmitting configuration information to controllable reflective surfaces. For example, the communication instructions 650 may be configured to cause a scheduling entity 600 to implement one or more of the functions described below in relation to FIG. 11, including, e.g., blocks 1102 and/or 1104. In one or more examples, the computer-readable storage medium 606 may further store computer-executable code that includes reflective surface configuration instructions 652 that configure a scheduling entity 600 for various functions, including, e.g., determining and/or generating configuration information for controllable reflective surfaces. For example, the reflective surface configuration instructions 652 may be configured to cause a scheduling entity 600 to implement one or more of the functions described below in relation to FIG. 11, including, e.g., blocks 1102 and/or 1104.

In one configuration, the scheduling entity 600 for wireless communication includes means for transmitting configuration information to controllable reflective surfaces, means for determining and/or generating configuration information for controllable reflective surfaces. In one aspect, the aforementioned means may be the processor(s) 604 shown in FIG. 6 configured to perform the functions recited by the aforementioned means. In another aspect, the aforementioned means may be a circuit or any apparatus configured to perform the functions recited by the aforementioned means.

Of course, in the above examples, the circuitry included in the processor 604 is merely provided as an example, and other means for carrying out the described functions may be included within various aspects of the present disclosure, including but not limited to the instructions stored in the computer-readable storage medium 606, or any other suitable apparatus or means described in any one of the FIGS. 1, 2, 3, and/or 5, and utilizing, for example, the processes and/or algorithms described herein in relation to FIG. 11.

FIG. 7 is a conceptual diagram illustrating an example of a hardware implementation for an exemplary controllable reflective surface 700 employing a processing system 714. In accordance with various aspects of the disclosure, a processing system 714 may include an element, or any portion of an element, or any combination of elements having one or more processors 704. For example, the controllable reflective surface 700 may be a controllable reflective surface as illustrated in any one or more of FIGS. 2, 5A-B, 8, 12A, 12B, 13A, 13B, 14A, and 14B.

The processing system 714 may be substantially the same as the processing system 614 illustrated in FIG. 6, including a bus interface 708, a bus 702, memory 705, a processor 704, and a computer-readable medium 706. Furthermore, the controllable reflective surface 700 may include a communication interface 709 substantially similar to the communication interface 609 described above in FIG. 6. For example, the communication interface 709 may include a transceiver 710 for wireless communications that is substantially similar to the transceiver 610 of FIG. 6 and a wired interface 711 for wired communications that is substantially similar to the wired interface 611 of FIG. 6. The controllable reflective surface 700 may further include a set (e.g., a two-dimensional (2D) array) of reflecting elements 712. The array of reflecting elements 712 may include phase shifting elements 715 and radiating elements 716. In some examples, each reflecting element 712 may include a respective phase shifting element and radiating element of the phase shifting elements 715 and radiating elements 716. The controllable reflective surface 700 may further include a panel interface 720. The bus interface 708 provides an interface between the bus 702 and the panel interface 720. The processing system 714 may communicate with the array of reflecting elements 712 via the panel interface 720. The controllable reflective surface 700 may further include a power supply 725. The power supply 725 is configured to power one or more of the processing system 714, the communication interface 709, the panel interface 720, and the array of reflecting elements 712. Although not illustrated in FIG. 6, a similar power supply may be provided in the scheduling entity 600 to power one or more components thereof.

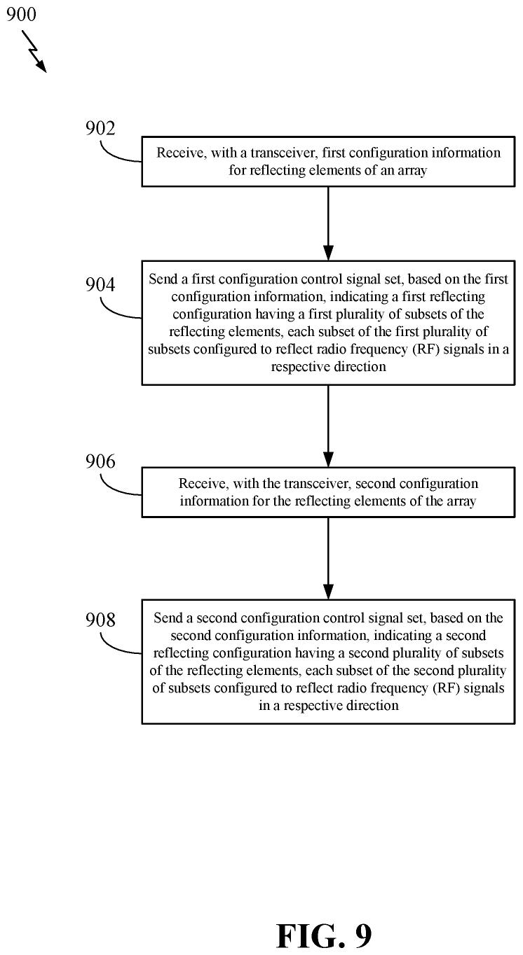

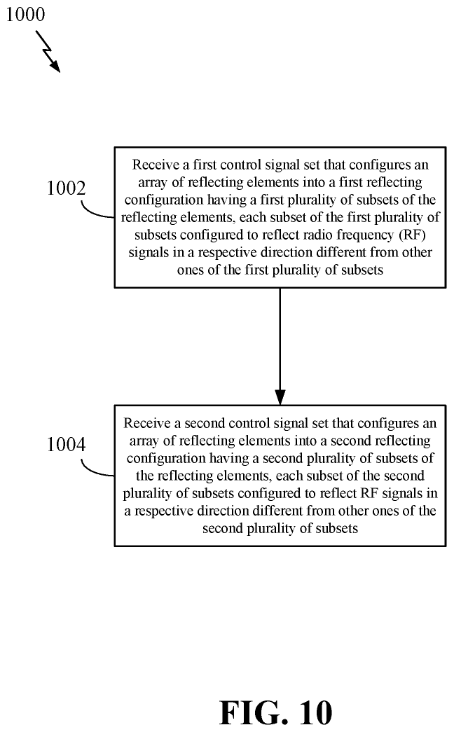

Additionally, the processor 704, as utilized in a controllable reflective surface 700, may be configured (e.g., in coordination with the memory 705) to implement any one or more of the processes described below and illustrated in FIG. 9. Additionally, the array of reflecting elements 712 may be configured to implement any one or more of the processes described below and illustrated in FIG. 10.

In some aspects of the disclosure, the processor 704 may include communication circuitry 740 configured (e.g., in coordination with the memory 705) for various functions, including, for example, receive configuration information from a scheduling entity via the communication interface 709 and send configuration control signals to the array of reflecting elements 712 via the panel interface 720 to configure the array of reflecting elements 712. For example, the communication circuitry 740 may be configured to implement one or more of the functions described below in relation to FIG. 9 including, e.g., blocks 902, 904, 906, and/or 908. In some aspects of the disclosure, the processor 704 may include array configuration circuitry 742 configured (e.g., in coordination with the memory 705) for various functions, including, for example, determine and/or generate configuration control signals for the array of reflecting elements 712 based on configuration information. For example, the array configuration circuitry 742 may be configured to implement one or more of the functions described below in relation to FIG. 9 including, e.g., blocks 902, 904, 906, and/or 908.

And further, the computer-readable storage medium 706 may store computer-executable code that includes communication instructions 750 that configure a controllable reflective surface 700 for various functions, including, e.g., receive configuration information from a scheduling entity via the communication interface 709 and send configuration control signals to the array of reflecting elements 712 via the panel interface 720 to configure the array of reflecting elements 712. For example, the communication instructions 750 may be configured to cause a controllable reflective surface 700 to implement one or more of the functions described below in relation to FIG. 9, including, e.g., blocks 902, 904, 906, and/or 908. The computer-readable storage medium 706 may further store computer-executable code that includes array configuration instructions 752 that configure a controllable reflective surface 700 for various functions, including, e.g., determine and/or generate configuration control signals for the array of reflecting elements 712 based on configuration information. For example, the array configuration instructions 752 may be configured to cause a controllable reflective surface 700 to implement one or more of the functions described below in relation to FIG. 9, including, e.g., blocks 902, 904, 906, and/or 908.

In one configuration, the controllable reflective surface 700 for wireless communication includes means for receiving configuration information from a scheduling entity, means for sending configuration control signals to the array of reflecting elements 712, means for determining and/or generating configuration control signals to configure the array of reflecting elements 712 based on configuration information. In one aspect, the aforementioned means may be the processor(s) 704 shown in FIG. 7 configured to perform the functions recited by the aforementioned means. In another aspect, the aforementioned means may be a circuit or any apparatus configured to perform the functions recited by the aforementioned means.

Of course, in the above examples, the circuitry included in the processor 704 is merely provided as an example, and other means for carrying out the described functions may be included within various aspects of the present disclosure, including but not limited to the instructions stored in the computer-readable storage medium 706, or any other suitable apparatus or means described in any one of the FIGS. 1, 2,3, 5A, 5B, 8, and/or 12A-14B, and utilizing, for example, the processes and/or algorithms described herein in relation to FIG. 9.

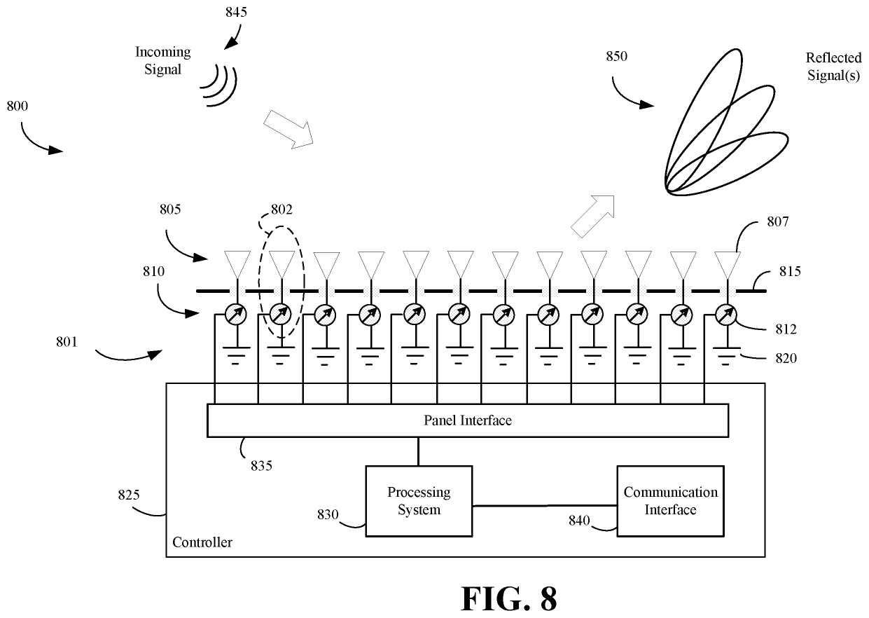

FIG. 8 illustrates a diagram of a controllable reflective surface 800 according to some embodiments. The controllable reflective surface 800 is an example of the controllable reflective surface 252 of FIG. 2 and 555 of FIG. 5B, and may be implemented by the controllable reflective surface 700 of FIG. 7. The controllable reflective surface 800 includes an array 801 of reflecting elements 802 (e.g., similar to the array 712 of FIG. 7). More particularly, the array 801 of reflecting elements 802 includes an array of radiating components 805 (e.g., including radiating component 807) and phase shifting components 810 (e.g., including phase shifting component 812). Each radiating component 805 is coupled to a respective phase shifting component 810, and each resulting pair forms a reflecting element 802 of the array 801. For example, the radiating component 807 and the phase shifting component 812 form a reflecting element 802. Each radiating component 805 may be separated from its associated phase shifting component 810 by surface or plane 815. Each phase shifting component 810 may also be coupled to ground 820. Although the array 801 of reflecting elements 802 is illustrated as a one dimensional linear array, in some examples, the array is two dimensional and/or has another array shape.

The controllable reflective surface 800 further includes a controller 825, which may also be referred to as a controller and power supply. In some examples, the controller 825 may be implemented by the processing system 714 of FIG. 7, or the processing system 714 and one or more of the panel interface 720, the communication interface 709, and the power supply 725 of FIG. 7. For example, returning to FIG. 8, the controller 825 may include a processing system 830 (e.g., implemented by the processing system 714), a panel interface 835 (e.g., implemented by the panel interface 720), and a communication interface 840 (e.g., implemented by the communication interface 709). The controller 825 is coupled to each phase shifting component 810 by the panel interface 835. The panel interface 835 may include a control line for each phase shifting component 810 to provide control signals thereto. The controller 825 may provide a set of one or more control signals (a control signal set) to the array 801 of reflecting elements 802 via the panel interface 835 to configure the reflecting elements 802 to reflect RF signals in one or more directions, as described in further detail below. For example, the control signal set to the array 801 may include a set of signals with a signal for each phase shifting component 810 to indicate or modify an amount of phase shift provided by a particular phase shifting component 810.

Each radiating component 805 is, for example, single or dual-pole radiator or antenna. Each phase shifting component 810 may include one or more phase shifters. For example, each phase shifting component 810 may include two, three, or four phase shifters for controlling the phase shifting of a particular radiating component 805. The phase shifters may include a switchable capacitor array, an analog varactor, and/or an analog (e.g., voltage-controlled) phase shifter. For example, with an analog phase shifter, the controller 825 may control the phase shift by increasing or decreasing a voltage level on the control line of the panel interface 835 connecting the controller 825 to the particular phase shifter. Accordingly, a control signal set from the panel interface 835 to the array 801 may include a set of voltage signals, one for each control line of each phase shifting component 810.

In operation, the controllable reflecting surface 800 may reflect an incoming signal 845 as one or more reflected signals 850. The controller 825 may control the array 801 of reflecting elements 802 to control characteristics of the reflected signals 850, such as the number of reflected signals, an angle of reflection of each reflected signal, and/or a width of each reflected signal. For example, the controller 825 may control the characteristics of the one or more reflected signals 850 by controlling the phase shifting elements 810. By varying the phase shift of a particular phase shifting component 810, the angle of reflection changes for the reflecting element 802 having that phase shifting component 810. In some examples, the controllable reflective surface 800 may have a field of view of plus or minus (+/−) 45 degrees or +/−60 degrees from a line extending away perpendicular to the array 801. In other words, the reflecting elements 802 of the controllable reflective surface 800 may be configured to receive an incoming signal 845 and effectively reflect the signal as intended when the incoming signal 845 approaches the controllable reflective surface 800 at an angle that is within the field of view. In these examples, the effectiveness of the reflection of the incoming signal 845 may decline as the approach angle of the incoming signal 845 reaches or exceeds the boundary of the field of view.

As noted above, a controllable reflective surface, such as the controllable reflective surfaces 252, 555, 700, and 800, may be configured to reflect signals in multiple directions simultaneously to provide spatial or coverage diversity. This spatial or coverage diversity can be useful or beneficial in various scenarios, such as, for example, for a broadcast channel, a multicast data transmission, a reference channel for multiple users, some physical control channels, among others. For example, with reference to FIG. 5B, by reflecting communications in multiple directions and providing coverage areas 560 and 565, the controllable reflective surface 555 may provide the UE 515 in the coverage area 560 with access to the base station 505, as well as provide a UE (not shown) in the coverage area 565 with access to the base station 505. In contrast, if the controllable reflective surface 555 were only to reflect signals towards the UE 515 to extend coverage, the extended coverage may not encompass a UE located higher up in the building 507 (such as a UE that would be in the coverage area 565).

FIG. 9 is a flow chart illustrating an exemplary process 900 for a controller for a controllable reflective surface in accordance with some aspects of the present disclosure. As described below, a particular implementation may omit some or all illustrated features, and may not require some illustrated features to implement all embodiments. In some examples, the processing system 714 illustrated in FIG. 7, or the controllable reflective surface 700, may be configured to carry out the process 900. In some examples, the controller 825 illustrated in FIG. 8, or the controllable reflective surface 800, may be configured to carry out the process 900. For purposes of explanation, the process 900 is described with respect to the controllable reflective surface 800 of FIG. 8. However, in some examples, any suitable apparatus or means for carrying out the functions or algorithm described below may carry out the process 900.

At block 902, the controller 825 receives, with the communication interface 840, first configuration information for reflecting elements of the array 801 of reflecting elements 802. For example, a scheduling entity (e.g., a base station) may send the configuration information to the controller 825. In some examples, the scheduling entity may transmit the configuration information in a wireless communication to the controller 825. The controller 825 may receive the wireless communication via a transceiver of the communication interface 840 (e.g., similar to the transceiver 710 of FIG. 7). For example, the wireless communication may be sent according to one of the protocols described above with respect to the RAN 104 (e.g., one or more of 5G NR, NG-RAN, or LTE). In some examples, a scheduling entity may transmit the configuration information in a wired communication to the controller 825. The controller 825 may receive the wired communication via a wired interface of the communication interface 840 (e.g., similar to the wired interface 711 of FIG. 7). As described in further detail below, the first configuration information may take various forms and include various data to indicate a first reflecting configuration for the array 801 of reflecting elements 802.

At block 904, the controller 825 sends, with the panel interface 835, a first configuration control signal set, based on the first configuration information. The first configuration control signal set (also referred to as the first control signal set) indicates a first reflecting configuration for the array 801. The first reflecting configuration has a first plurality of subsets of the reflecting elements 802, and each subset of the first plurality of subsets is configured to reflect radio frequency (RF) signals in a respective direction different from other ones of the first plurality of subsets. For example, when the first plurality of subsets of the first reflecting configuration has two subsets, a first subset may reflect RF signals in a first direction, and a second subset may reflect RF signals in a second direction that is different than the first direction.

In some examples, the first control signal set may include a set of control signals, one control signal for the phase shifting component 810 of each reflecting element 802 of the array 801. For the controller 825 to send the first control signal set, the processing system 830 may send this set of control signals via the panel interface 835 to the phase shifting components 810. In response, each phase shifting component 810 is configured to provide a corresponding phase shift to an incoming RF signal (e.g., incoming RF signal 845) received by its associated radiating component 805. As a result, each phase shifting component 810 is configured to reflect the incoming RF signal in a particular direction. Reflecting elements 802 that are configured to reflect in a similar direction may form or define a subset of reflecting elements.

As noted, the first control signal set is based on the first configuration information that is received in block 902. In some examples, the first configuration information includes respective phase control information for individual reflecting elements 802 of the array 801. For example, the configuration information may include phase control information for each reflecting element 802 of the array 801. The phase control information may indicate a value or configuration for each control signal of the first control signal set that the controller 825 sends to the respective phase shifting components 810 of the array 801. In such examples, the control signals of the first control signal set may be referred to as phase control signals. The controller 825 may provide the phase control signals to the array 801 via the panel interface 835. As a more particular example, the processing system 830 may provide each individual phase control signal, via the panel interface 835, to a respective one of the phase shifting components 810. These individual phase control signals configure the phase shifting components 810 and, thus, the array 801 of reflecting elements 802 into the first reflecting configuration. In such examples, the particular reflecting configuration and partitioning of reflecting elements into subsets may be generally transparent to the controller 825. The individual phase control signals may collectively form the first control signal set.

In other examples, the first configuration information includes one or more of partition information indicating subsets of the array 801 of the reflecting elements 802, and/or directional information for each indicated subset. For example, the partition information may identify the number of subsets of the first plurality of subsets of the first reflecting configuration. Additionally or alternatively, the partition information may indicate which of the reflecting elements 802 belong to each subset of the first plurality of subsets of the first reflecting configuration. As described in further detail below, two potential configurations for a subset may include a block (or localized set) of reflecting elements 802 for a block-wise configuration, and a distributed set of reflecting elements 802 for an interlaced configuration. In some examples, the reflecting configuration is a hybrid configuration. For example, in a first hybrid configuration, one or more reflective elements 802 may belong both to a subset having a block-wise configuration and to another subset having an interlaced configuration. In a second hybrid configuration, a subset may be configured to have a partially block-wise configuration and a partially interlaced configuration.

The directional information may indicate a respective direction for each subset of the plurality of subsets of the reflecting elements 802. For example, the directional information may include a precoding matrix index (PMI) for each subset. The PMI may index to a precoding matrix of a predefined codebook stored on a memory of the controller 825 (see, e.g., the memory 705 of FIG. 7). The precoding matrix may indicate weights for the particular subset and, more specifically, for the reflecting elements 802 of the subset. The controller 825 (e.g., the processing system 830) may translate the precoding matrix for each subset to a phase control signal for each reflecting element 802 of the subset. The phase control signals for the reflecting elements 802 of the plurality of subsets may collectively form the first control signal set. The processing system 830 may send, via the panel interface 835, the first control signal set to the array 801 of reflecting elements 802. The phase control signals of the first control signal set may configure the phase shifting components 810 and, thus, the array 801 of reflecting elements 802, into the first reflecting configuration.

For example, the weights or directional information (e.g., phase and amplitude) for each reflecting element may be determined for each axis of reflection that may be controlled. Accordingly, each of the reflecting elements 802 may participate in a partition or subset per axes (e.g., a partition or subset for the x-axis and a partition or subset for the y-axis). The reflecting elements 802 of the same partition or subset have the same or substantially the same beamforming angle for the respective axis. The weights or directional information for each axis may be multiplied or otherwise combined to provide a phase shift setting for the reflecting element 802 to achieve the desired reflection (or reflections). For example, the amplitude and phase for each reflecting element 802 may be determined using the following equation:

$${U}_{x , y} = {U}_{x} {U}_{y} ∼ A ( x ) A ( y ) = rect ( \frac{x}{{D}_{x}} ) rect ( \frac{y}{{D}_{y}} ) exp [ i 2 π \frac{x sin {θ}_{0 , x} + y sin {θ}_{0 , y}}{λ} ]$$

where A(x) and A(y) are aperture functions including the amplitude-phase profile of the intended beam reflection, θ_{o,x} is the target angle for the x-axis, θ_{o,y} is the target angle for the y-axis, x is the x-position of the reflecting element within the array 801, y is the y-position of the reflecting element 802 within the array 801, Dₓ is the separation of reflecting elements 802 in the array 801 in the x-direction, and D_{y} is the separation of reflecting elements 80 in the array 801 in the y-direction.

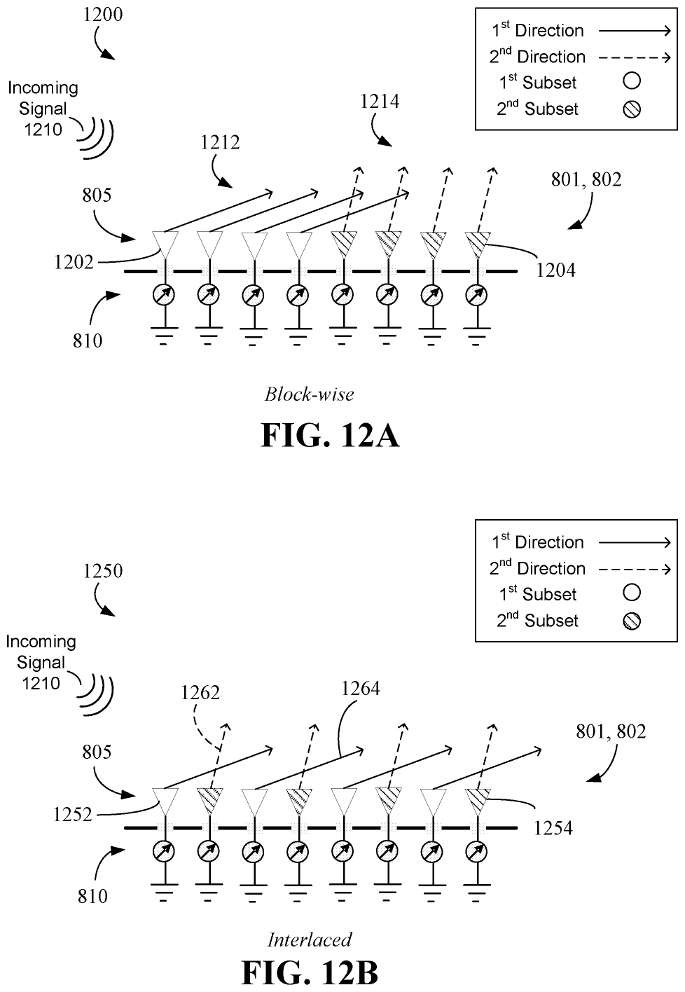

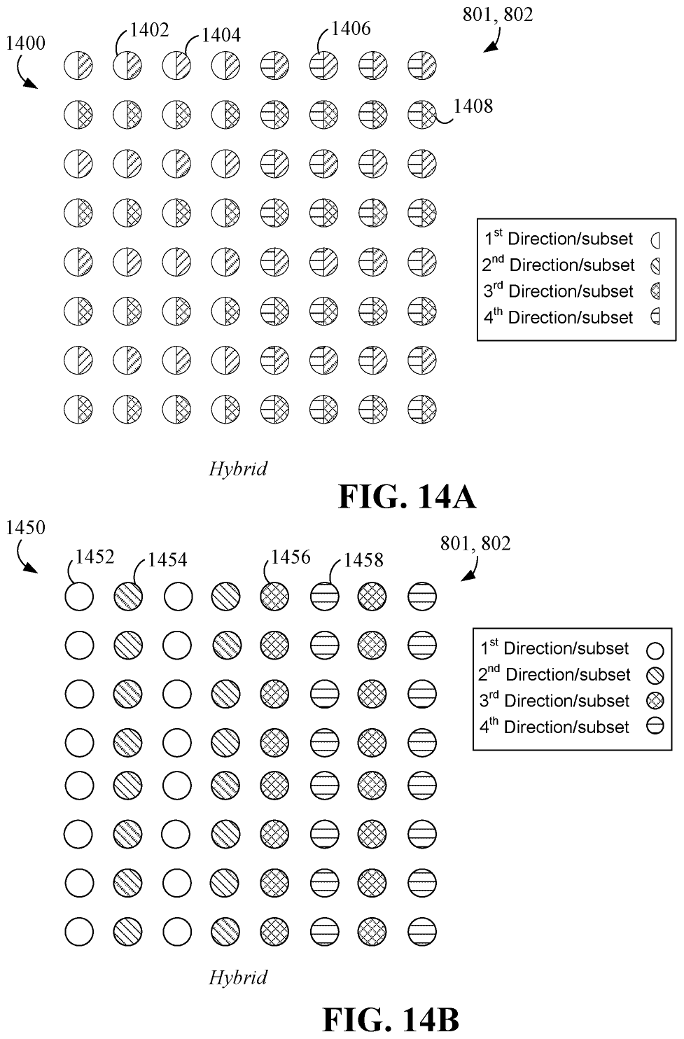

A reflecting configuration for the array 801 of reflecting elements 802, such as the first reflecting configuration of block 904, may take various forms. The first reflecting configuration may be similar to at least one of these example reflecting configurations of FIGS. 12A-14B, which are described in further detail below. For example, the subsets of the first plurality of subsets of the array 801 of reflecting elements 802 may have a block-wise configuration, such as shown in FIGS. 12A and/or 13A; may have an interlaced configuration such as shown in FIGS. 12B and/or 13B; and/or may have a hybrid configuration such as shown in FIGS. 14A and/or 14B.

At block 906, the controller receives, with the communication interface 840, second configuration information for the reflecting elements 802 of the array 801. For example, a scheduling entity (e.g., a base station) may send the second configuration information to the controller 825. In some examples, the scheduling entity may transmit the second configuration information in a wireless communication to the controller 825. The controller 825 may receive the wireless communication via a transceiver of the communication interface 840 (e.g., similar to the transceiver 710 of FIG. 7). For example, the wireless communication may be sent according to one of the protocols described above with respect to the RAN 104 (e.g., one or more of 5G NR, NG-RAN, or LTE). In some examples, the scheduling entity may transmit the configuration information in a wired communication to the controller 825. The controller 825 may receive the wired communication via a wired interface of the communication interface 840 (e.g., similar to the wired interface 711 of FIG. 7). As described in further detail below, the second configuration information may take various forms and include various data to indicate a second reflecting configuration for the array 801 of reflecting elements 802.

At block 908, the controller sends, with a panel interface, a second configuration control signal set, based on the second configuration information. For example, the controller 825 may send, via the panel interface 835, a second configuration control signal set based on the second configuration information. The second configuration control signal set (also referred to as the second control signal set) indicates a second reflecting configuration for the array 801. The second reflecting configuration has a second plurality of subsets of the reflecting elements 802, and each subset of the second plurality of subsets is configured to reflect RF signals in a respective direction different from other ones of the second plurality of subsets. For example, when the second reflecting configuration has two subsets, a first subset may reflect RF signals in a first direction, and a second subset may reflect RF signals in a second direction that is different than the first direction.

In some examples, the second control signal set may include a set of control signals, one control signal for the phase shifting component 810 of each reflecting element 802 of the array 801. For the controller 825 to send the second control signal set, the processing system 830 may send this set of control signals via the panel interface 835 to the phase shifting components 810. In response, each phase shifting component 810 is configured to provide a phase shift of a particular amount to an incoming RF signal (e.g., incoming RF signal 845) received by its associated radiating component 805. As a result, each phase shifting component 810 is configured to reflect the incoming RF signal in a particular direction. Reflecting elements 802 that are configured to reflect in a similar direction may form or define a subset of reflecting elements.

As noted, the second control signal set is based on the second configuration information that is received in block 906. In some examples, as described above with respect to block 904 and the first configuration information, the second configuration information may indicate values or configurations for respective phase control signals that the controller 825 sends to individual reflecting elements of the array 801 of reflecting elements 802. The individual phase control signals may collectively form the second control signal set.

In other examples, the second configuration information includes one or more of partition information indicating subsets of the array 801 of reflecting elements 802 and directional information for each indicated subset. The partition information may one or more of identify the number of subsets of the second plurality of subsets of the second reflecting configuration and indicate which of the reflecting elements 802 belong to each subset of the second plurality of subsets of the second reflecting configuration. The directional information may indicate a respective direction for each subset of the plurality of subsets of the reflecting elements 802. The partition information and directional information of the second configuration information may be similar in format to the partition information and directional information of the first configuration information described above. However, the particular partitioning and/or indicated directions for the array 801 of reflecting elements 802 may be different in the second configuration information than the first configuration information. The controller 825 may translate the partition information and/or the directional information to generate the phase control signals of the second control signal set. The controller 825 may then send the phase control signals, as the second control signal set, to configure the phase shifting components 810 and, thus, the array 801 of reflecting elements 802, into the second reflecting configuration.

A reflecting configuration for the array 801 of reflecting elements 802, such as the second reflecting configuration of block 908, may take various forms. The second reflecting configuration may be similar to at least one of these example reflecting configurations of FIGS. 12A-14B, which are described in further detail below. For example, the subsets of the second plurality of subsets of the array 801 of reflecting elements 802 may have a block-wise configuration, such as shown in FIGS. 12A and/or 13A; may have an interlaced configuration such as shown in FIGS. 12B and/or 13B; and/or may have a hybrid configuration such as shown in FIGS. 14A and/or 14B.

Accordingly, in the process 900, the controller 825 may configure the array 801 of reflecting elements 802 into a first and second reflecting configuration. Each of the first and second reflecting configuration may have one or both of different subsets of the reflecting elements 802 and subsets that are differently configured to reflect an incoming signal into different spatial directions.

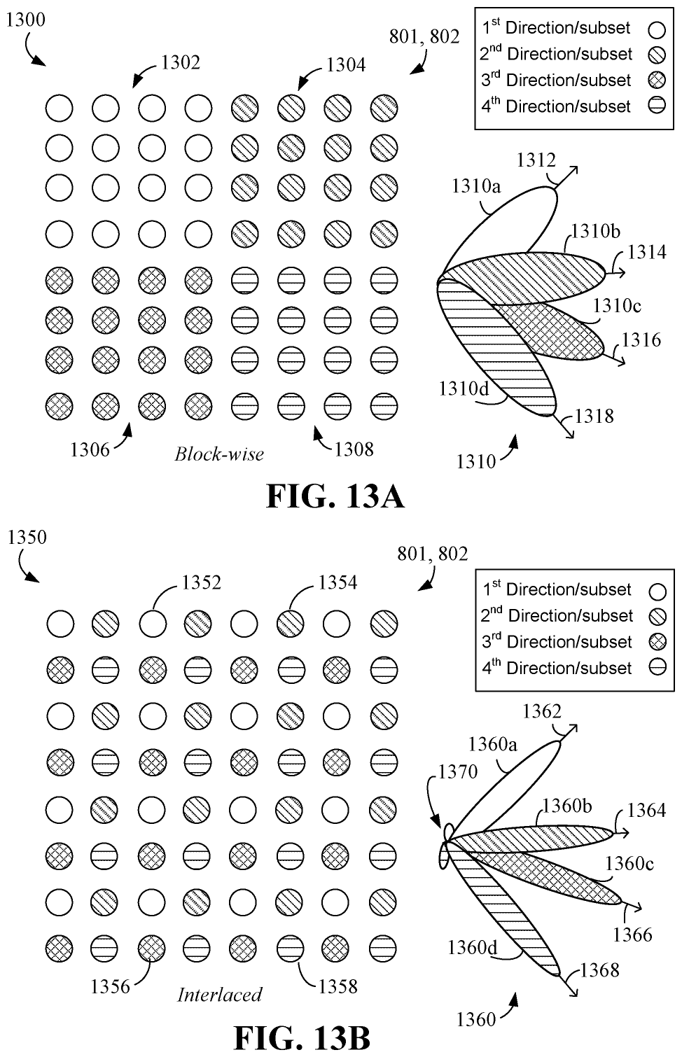

In some examples, the subsets of the first plurality of subsets of the first reflecting configuration have a block-wise configuration (like FIG. 12A or 13A), an interlaced configuration (like FIG. 12B or 13B), or a hybrid configuration (like FIG. 14A or 14B). In some examples, the subsets of the second plurality of subsets of the second reflecting configuration have a block-wise configuration (like FIG. 12A or 13A), an interlaced configuration (like FIG. 12B or 13B), or a hybrid configuration (like FIG. 14A or 14B). In some examples, the first reflecting configuration is different than the second reflecting configuration. For example, the first reflecting configuration is one of a block-wise configuration, an interlaced configuration, or a hybrid configuration, and the second reflecting configuration is a different one of a block-wise configuration, an interlaced configuration, and a hybrid configuration. In some examples, the first reflecting configuration and the second reflecting configuration both have a block-wise configuration, an interlaced configuration, or a hybrid configuration, but, the subsets of the first and second reflecting configurations are controlled to have different reflecting directions. For example, the first and second reflecting configurations may have the same partition information, but different directional information.

In some examples, the process 900 may continue to loop back to block 902 or to block 906 to receive further configuration information (e.g., third configuration information, fourth configuration information, fifth configuration information, etc.) as the controllable reflective surface 800 continues to operate. Accordingly, the controller 825 may, over time, reconfigure the array of reflective elements 802 into each respectively received instance of configuration information.

FIG. 10 is a flow chart illustrating an exemplary process 1000 for a controllable reflective surface in accordance with some aspects of the present disclosure. As described below, a particular implementation may omit some or all illustrated features, and may not require some illustrated features to implement all embodiments. In some examples, the controllable reflective surface 700, may be configured to carry out the process 1000. In some examples, the controllable reflective surface 800, may be configured to carry out the process 1000. For purposes of explanation, the process 1000 is described with respect to the controllable reflective surface 800 of FIG. 8. However, in some examples, any suitable apparatus or means for carrying out the functions or algorithm described below may carry out the process 1000.

At block 1002, the controllable reflective surface 800 receives a first control signal set that configures the array 801 of the reflecting elements 802 into a first reflecting configuration. Each reflecting element 802 of the array 801 includes a radiating component 805 and a phase-shifting component 810. The first reflecting configuration has a first plurality of subsets of the reflecting elements 802. Each subset of the first plurality of subsets configured to reflect radio frequency (RF) signals in a respective direction different from other ones of the first plurality of subsets. For example, the array 801 may receive the first control signal set from the controller 825, such as described above with respect to block 904. For example, the first control signal set may include a plurality of phase control signals that each set the phase shift amount of a respective one of the phase shifting components 810 of the array 801. By setting the phase shift amount of each phase shifting components 810, the reflecting element 802 associated with each phase shifting component 810 is configured to belong to one or more of the first plurality of subsets. More particularly, by setting the phase shift amount of each phase shifting components 810, the reflecting element 802 associated with each phase shifting component 810 is configured to reflect an incoming signal in a particular direction (or directions, in the case of some hybrid configurations). Those reflecting elements 802 configured to reflect an incoming signal in a similar direction may be considered part of the same subset of the first plurality of subsets.

At block 1004, the controllable reflective surface 800 receives a second control signal set that configures the array 801 of the reflecting elements 802 into a second reflecting configuration. The second reflecting configuration has a second plurality of subsets of the reflecting elements 802. Each subset of the second plurality of subsets configured to reflect RF signals in a respective direction. For example, the array 801 may receive the second control signal set from the controller 825, such as described above with respect to block 908. For example, the second control signal set may include a plurality of phase control signals that each set the phase shift amount of a respective one of the phase shifting components 810 of the array 801. By setting the phase shift amount of each phase shifting components 810, the reflecting element 802 associated with each phase shifting component 810 is configured to belong to one or more of the first plurality of subsets. More particularly, by setting the phase shift amount of each phase shifting components 810, the reflecting element 802 associated with each phase shifting component 810 is configured to reflect an incoming signal in a particular direction (or directions, in the case of some hybrid configurations). Those reflecting elements 802 configured to reflect an incoming signal in a similar direction may be considered part of the same subset of the second plurality of subsets.

The first and second reflecting configurations may be similar to at least one of the example reflecting configurations of FIGS. 12A-14B, which are described in further detail below. For example, the first and second reflecting configurations may have a block-wise configuration, such as shown in FIGS. 12A and/or 13A; may have an interlaced configuration such as shown in FIGS. 12B and/or 13B; and/or may have a hybrid configuration such as shown in FIGS. 14A and/or 14B. In the process 1000, the first and second reflecting configuration may be different from one another. For example, each of the first and second reflecting configuration may have one or both of different subsets of the reflecting elements 802 and subsets that are differently configured to reflect an incoming signal into different spatial directions.

In some examples, the subsets of the first plurality of subsets of the first reflecting configuration have a block-wise configuration (like FIG. 12A or 13A), an interlaced configuration (like FIG. 12B or 13B), or a hybrid configuration (like FIG. 14A or 14B). In some examples, the subsets of the second plurality of subsets of the second reflecting configuration have a block-wise configuration (like FIG. 12A or 13A), an interlaced configuration (like FIG. 12B or 13B), or a hybrid configuration (like FIG. 14A or 14B). In some examples, the first reflecting configuration is different than the second reflecting configuration. For example, the first reflecting configuration is one of a block-wise configuration, an interlaced configuration, or a hybrid configuration, and the second reflecting configuration is a different one of a block-wise configuration, an interlaced configuration, and a hybrid configuration. In some examples, the first reflecting configuration and the second reflecting configuration both have a block-wise configuration, an interlaced configuration, or a hybrid configuration, but, the subsets of the first and second reflecting configurations are controlled to have different reflecting directions. For example, the first and second reflecting configurations may have the same partition information, but different directional information.

In some examples, the process 1000 may continue to loop back to block 1002 or to block 1004 such that the controllable reflective surface 800 receives further control signal sets and is further reconfigured (e.g., into a third reflecting configuration, fourth reflecting configuration, fifth reflecting configuration, etc.) as the controllable reflective surface 800 continues to operate. Accordingly, the controllable reflective surface 800 may, over time, be reconfigured according to further received control signals.

FIG. 11 is a flow chart illustrating an exemplary process 1100 for a scheduling entity to configure a controllable reflective surface in accordance with some aspects of the present disclosure. As described below, a particular implementation may omit some or all illustrated features, and may not require some illustrated features to implement all embodiments. In some examples, the scheduling entity 600 illustrated in FIG. 6 may be configured to carry out the process 1100. For purposes of explanation, the process 1100 is described with respect to the scheduling entity 600 of FIG. 6 and the controllable reflective surface 800 of FIG. 8. However, in some examples, any suitable apparatus or means for carrying out the functions or algorithm described below may carry out the process 1100. For example, another scheduling entity may carry out the functions of the process 1100, and this other scheduling entity may transmit signals to configure a controllable reflective surface other than the controllable reflective surface 800 (e.g., the controllable reflective surface 700 or any other suitable controllable reflective surface, apparatus, or means).

At block 1102, the scheduling entity 600 transmits, with the communication interface 609, first configuration information for the reflecting elements 802 of the array 801. The first configuration information indicates a first reflecting configuration for the array 801. The first reflecting configuration has a first plurality of subsets of the reflecting elements 802. Each subset of the first plurality of subsets is configured to reflect radio frequency (RF) signals in a respective direction different from other ones of the first plurality of subsets.

For example, as described above with respect to block 902 of FIG. 9, the scheduling entity 600 (e.g., a base station) may send the first configuration information to the controller 825 of the controllable reflective surface 800. In some examples, the scheduling entity 600 may transmit the configuration information in a wireless communication to the controller 825 via the transceiver 610. For example, the wireless communication may be sent according to one of the protocols described above with respect to the RAN 104 (e.g., one or more of 5G NR, NG-RAN, or LTE). In some examples, the scheduling entity 600 may transmit the configuration information in a wired communication to the controller 825 via wired interface 611.

As also described above, the first configuration information may take various forms and include various data to indicate a first reflecting configuration for the array 801 of reflecting elements 802. For example, as described above with respect to block 904 of FIG. 9, the first configuration information may indicate values or configurations for respective phase control signals for individual reflecting elements of the array 801 of reflecting elements 802. The individual phase control signals may collectively form a first control signal set used by the controller 825 to configure the array 801.

In other examples, the first configuration information includes one or more of partition information indicating subsets of the array 801 of reflecting elements 802 and directional information for each indicated subset. The partition information and directional information of the first configuration information may be similar in format to the partition information and directional information described above with respect to block 904. For example, the partition information may one or more of identify the number of subsets of the first plurality of subsets of the first reflecting configuration and indicate which of the reflecting elements 802 belong to each subset of the second plurality of subsets of the second reflecting configuration. The directional information may indicate a respective direction for each subset of the first plurality of subsets of the reflecting elements 802.

At block 1104, the scheduling entity 600 transmits, with the communication interface 609, second configuration information for the reflecting elements 802 of the array 801. The second configuration information indicates a second reflecting configuration for the array 801. The second reflecting configuration has a second plurality of subsets of the reflecting elements 802. Each subset of the second plurality of subsets is configured to reflect RF signals in a respective direction different from other ones of the second plurality of subsets.

For example, as described above with respect to block 906 of FIG. 9, the scheduling entity 600 (e.g., a base station) may send the first configuration information to the controller 825 of the controllable reflective surface 800. In some examples, the scheduling entity 600 may transmit the configuration information in a wireless communication to the controller 825 via the transceiver 610. For example, the wireless communication may be sent according to one of the protocols described above with respect to the RAN 104 (e.g., one or more of 5G NR, NG-RAN, or LTE). In some examples, the scheduling entity 600 may transmit the configuration information in a wired communication to the controller 825 via wired interface 611.

As also described above, the first configuration information may take various forms and include various data to indicate a first reflecting configuration for the array 801 of reflecting elements 802. For example, as described above with respect to block 904 of FIG. 9, the first configuration information may indicate values or configurations for respective phase control signals for individual reflecting elements of the array 801 of reflecting elements 802. The individual phase control signals may collectively form a first control signal set used by the controller 825 to configure the array 801. In other examples, the first configuration information includes one or more of partition information indicating subsets of the array 801 of reflecting elements 802 and directional information for each indicated subset. The partition information and directional information of the first configuration information may be similar in format to the partition information and directional information described above with respect to block 904 and block 1102.

In some examples of the processes 900, 1000, and 1100, the partition information and directional information, also referred to as weighting information, may be signaled separately. For example, the scheduling entity 600 may transmit the partition information more frequently than the weighting information. Accordingly, in some examples, the partition information may be semi-static, while the directional information is dynamic. For example, at a first time, the scheduling entity 600 may transmit partition information that defines the number of subsets and/or the reflecting elements 802 of the array 801 of each subset. At a second (later) time, the scheduling entity 600 may transmit directional information indicating respective direction for each subset of the reflecting elements 802 indicated by the partition information. This partition information and directional information may combine to define a first reflecting configuration for the array 801. At a third (later) time, the scheduling entity 600 may transmit further directional information that updates the respective direction for each subset of the reflecting elements 802 indicated by the partition information. The partition information from the first time and the further directional information may combine to define a second reflecting configuration for the array 801. In this way, the directional information is dynamic and the partition information is semi-static. In some examples, the partition information and the directional information are both dynamic, but still transmitted separately. In some examples, the directional information is conditioned on the latest received partition information. For example, the controller 825 may have received and stored multiple sets of directional information, each set of directional information associated with particular partition information in the controller 825. Then, in response to receiving partition information, the controller 825 will select the directional information associated with that partition information and configure the array 801 in a reflecting configuration defined by the partition information and the associated directional information. Accordingly, the controller 825 will configure the array 801 based on the latest received partition information in combination with directional information associated with that partition information.

In some examples, the partition information and directional information may be transmitted or signaled jointly. For example, the scheduling entity 600 may jointly encode the partition information and directional information (e.g., which may be concatenated before encoding), and then transmit the jointly encoded information.

In other examples of joint signaling, the scheduling entity 600 may separately encode the partition information and the directional information, concatenate the separate encodings, and then transmit the concatenated encodings (e.g., as part of one wireless transmission). In some examples, the concatenation may include two encoded parts: a first part indicating a number of subsets and, optionally, the type of subsets; and a second part including more particular partition information (e.g., identifying the reflecting elements 802 belonging to each subset) and directional information (e.g., weighting information for each subset). In some examples, the first part may have a fixed payload size, and the second part may have a variable payload size, which a receiving device (e.g., the controller 825) can identify by decoding the first part. In some further examples, the concatenation may include three encoded parts: a first part indicating a number of subsets and, optionally, the type of subsets; a second part including more particular partition information (e.g., identifying the reflecting elements 802 belonging to each subset); and a third part including directional information (e.g. weighting information for each subset). In some examples, the first part may have a fixed payload size; the second part may have a variable payload size, which can be identified by a receiving device (e.g., the controller 825) decoding the first part; and the third part may have a variable payload size, which a receiving device (e.g., the controller 825) can identify by decoding the first part and/or the second part.

In some examples, the scheduling entity 600 determines and transmits the configuration information (e.g., the first and second configuration information) to the controllable reflecting surface 800 as part of a beam sweeping procedure. For example, the scheduling entity 600 may transmit a wireless signal or wireless signals (e.g., an SS block or SS blocks) in coordination with transmitting configuration information to the controllable reflecting surface 800 (e.g., in accordance with the process 1100) to change the angles of reflection of the controllable reflecting surface 800. As a result, the wireless signal (or signals) are swept in different spatial directions. A UE may receive the SS block and respond to the scheduling entity 600 with a channel estimate. The controllable reflecting surface 800 may reflect the channel estimate to the scheduling entity 600. The scheduling entity 600 may then select a particular beam and reflecting configuration for the controllable reflecting surface 800 based on the channel estimation. For example, the scheduling entity 600 may select the particular beam and reflecting configuration that resulted in the best channel estimation. The scheduling entity 600 may then transmit configuration information to configure the controllable reflecting surface 800 to have the selected reflecting configuration. The scheduling entity 600 and the UE may then commence with further uplink and/or downlink communications utilizing the controllable reflecting surface 800 to reflect the communications between the devices. This beam sweeping procedure may occur, for example, as part of an initial access procedure for a UE or in response to a beam failure.

In some examples, reflected signals from different subsets of the controllable reflecting surface 800 may overlap one another. Such overlapping may result in fluctuations in the strength of a composite waveform of one or both overlapping beams. To mitigate the fluctuations, the scheduling entity 600 may set an amplitude of one beam to be significantly larger than an amplitude of the other beam. In the case of multiple overlapping beams with one beam being a dominant beam, the resulting signal or signals can be modeled with a Ricean fading model.

As noted above, FIGS. 12A, 12B, 13A, 13B, 14A, and 14B (i.e., FIGS. 12A-14B) provide examples of reflecting configurations. The reflecting configurations in FIGS. 12A-14B are described with respect to examples of the controllable reflective surface 800; however, these reflecting configurations may similarly apply to the controllable reflective surface 700. For clarity in the description of the example reflecting configurations, the controller 825 of FIG. 8 is not illustrated in FIGS. 12A-14B. However, the controller 825 may be present in each of the embodiments illustrated in FIGS. 12A-14B in a similar arrangement and with similar functionality as described above with respect to FIG. 8.

FIG. 12A illustrates the array 801 of reflecting elements 802 of the controllable reflective surface 800 in a block-wise configuration 1200. As previously described, each reflecting element 802 includes a radiating component 805 and a phase shifting component 810. In FIG. 12A, the array 801 of reflecting elements 802 includes a first subset 1202 and a second subset 1204. To distinguish subsets, each subset is illustrated with a unique fill pattern and one example radiating component 805 of each subset is labeled as 1202 or 1204. The first subset 1202 includes four of the reflecting elements 802. The first subset 1202 reflects an incoming signal 1210 as a reflected signal 1212 in a first direction. The second subset 1204 includes the other four of the reflecting elements 802. The second subset 1204 reflects the incoming signal 1210 as a reflected signal 1214 in a second direction. The reflected signal from a particular subset is a combination of the individual signals reflected by each reflecting element 802 of that subset. In a block-wise configuration, one or more subsets or each subset of reflecting elements form a respective block of localized reflecting elements. A subset of reflecting elements form a block of localized reflecting elements when, for example, each reflecting element of the subset is adjacent to at least one other reflecting element of that subset. Stated another way, the reflecting elements of a block of localized reflecting elements include a contiguous group of reflecting elements. As shown in FIG. 12A, the first subset of reflecting elements 802 is a contiguous group of four reflecting elements, which are a block of localized reflecting elements. Similarly, the second subset of reflecting elements 802 is another contiguous group of four reflecting elements, which are also a block of localized reflecting elements. Accordingly, the configuration 1200 of FIG. 12A may be referred to as a block-wise configuration.

FIG. 12B illustrates the array 801 of reflecting elements 802 of the controllable reflective surface 800 in an interlaced configuration 1250. In FIG. 12B, the array 801 of reflecting elements includes a first subset 1252 and a second subset 1254. To distinguish subsets, each subset is illustrated with a unique fill pattern and one example radiating component of each subset is labeled as 1252 or 1254. The first subset 1252 includes four of the reflecting elements 802. The first subset reflects the incoming signal 1210 as a reflected signal 1262 in a first direction. The second subset 1254 includes the other four of the reflecting elements 802. The second subset reflects the incoming signal 1210 as a reflected signal 1264 in a second direction. The reflected signal from a particular subset is a combination of the individual signals reflected by each reflecting element 802 of that subset. In an interlaced configuration, one or more subsets or each subset of reflecting elements form a distributed group of reflecting elements. A subset of reflecting elements form a distributed group of reflecting elements when, for example, each reflecting element of the subset is spaced apart from each other reflecting element by one or more intervening reflecting elements of another subset. Stated another way, the reflecting elements of a distributed group of reflecting elements include a noncontiguous group of reflecting elements. As shown in FIG. 12B, the first subset 1252 of reflecting elements 802 is a noncontiguous group of four reflecting elements and the second subset 1254 of reflecting elements 802 is another noncontiguous group of four reflecting elements. As shown, reflecting elements 802 of the second subset 1254 are located between reflecting elements 802 of the first subset 1252. Described another way, at least one reflecting element 802 of the second subset 1254 is located between any two reflecting elements 802 of the first subset 1252, and at least one reflecting element 802 of the first subset 1252 is located between any two reflecting elements 802 of the second subset 1254. Thus, the first and second subsets 1252, 1254 of reflecting elements 802 are interlaced in FIG. 12B. Accordingly, the configuration 1200 of FIG. 12A may be referred to as an interlaced configuration.

FIGS. 12A and 12B illustrate a one-dimensional array 801 of eight reflecting elements 802. However, the array 801 may include any number of reflecting elements 802. Additionally, the array 801 may be a two-dimensional array 801 of reflecting elements 802. For example, FIGS. 13A, 13B, 14A, and 14B illustrate embodiments of the array of reflecting elements 802 being two-dimensional (2D) arrays. While FIGS. 12A and 12B illustrate a profile view of the array 801 of reflecting elements 802, FIGS. 13A, 13B, 14A, and 14B illustrate a top-down view of the array 801 of reflecting elements 802.

FIG. 13A illustrates the array 801 of reflecting elements 802 of the controllable reflective surface 800 in a block-wise configuration 1300. In FIG. 13A, the array 801 of reflecting elements 802 includes a two-dimensional (8×8) array 801 of reflecting elements 802. In the block-wise configuration 1300, the array 801 of reflecting elements 802 is partitioned into four subsets 1302, 1304, 1306, and 1308. Each subset 1302, 1304, 1306, and 1308 includes a block of sixteen of the reflecting elements 802 located in a respective quadrant of the two-dimensional array 801. The plurality of subsets of the array 801 of reflecting elements 802 reflect an incoming signal (not shown, but similar to incoming signal 1210) as reflected signals 1310. Each subset reflects the incoming signal in a respective direction. For example, the reflecting elements 802 of the subset 1302 reflect the incoming signal as a reflected signal 1310a in a first direction 1312, the reflecting elements 802 of the subset 1304 reflect the incoming signal as a reflected signal 1310b in a second direction 1314, the reflecting elements 802 of the subset 1306 reflect the incoming signal as a reflected signal 1310c in a third direction 1316, and the reflecting elements 802 of the subset 1308 reflect the incoming signal as a reflected signal 1310d in a fourth direction 1318. The reflected signal (e.g., the reflected signal 1310a) from a particular subset (e.g., the subset 1302) is a combination of the individual signals reflected by each reflecting element 802 of that subset. The particular reflecting directions 1312-1318 illustrated in FIG. 13A are merely examples, as different phase shift settings for the reflecting elements 802 of each subgroup will produce different reflection directions.

FIG. 13B illustrates the array 801 of reflecting elements 802 of the controllable reflective surface 800 in an interlaced configuration 1350. In FIG. 13B, the array 801 of reflecting elements 802 includes a two-dimensional (8×8) array 801 of reflecting elements 802. In the interlaced configuration 1350, the array 801 of reflecting elements 802 are partitioned into four subsets 1352, 1354, 1356, and 1358. In FIG. 13B, to distinguish subsets, each subset is illustrated with a unique fill pattern and one example reflecting element of each subset is labeled as 1352, 1354, 1356, or 1358. Each subset 1352, 1354, 1356, and 1358 includes sixteen of the reflecting elements 802 distributed across the two-dimensional array 801. In each row, reflecting elements 802 of two of the subsets alternate going from left to right across each row, and the two subsets selected for each row alternate every other row as well. For example, in the first (top) row, the third row, the fifth row, and the seventh row, reflecting elements of the first subset 1352 and the second subset 1354 alternate (e.g., going from left to right across each respective row). Additionally, in the second, fourth, sixth, and eight row, reflecting elements of the third subset 1356 and the fourth subset 1358 alternate. Similarly, in each column, reflecting elements 802 of two of the subsets alternate from top to bottom, and the two subsets selected for each column alternate every other column as well. The plurality of subsets of the array of reflecting elements 802 reflect an incoming signal (not shown, but similar to incoming signal 1210) as reflected signals 1360. Each subset reflects the incoming signal in a respective direction. For example, the reflecting elements 802 of the subset 1352 reflect the incoming signal as a reflected signal 1360a in a first direction 1362, the reflecting elements 802 of the subset 1354 reflect the incoming signal as a reflected signal 1360b in a second direction 1364, the reflecting elements 802 of the subset 1356 reflect the incoming signal as a reflected signal 1360c in a third direction 1366, and the reflecting elements 802 of the subset 1358 reflect the incoming signal as a reflected signal 1360d in a fourth direction 1368. The reflected signal (e.g., the reflected signal 1360a) from a particular subset (e.g., the subset 1352) is a combination of the individual signals reflected by each reflecting element 802 of that subset. Additionally, as shown in FIG. 13B, the reflected signals 1360 include side lobes 1370. The particular reflecting directions 1362-1368 illustrated in FIG. 13B are merely examples, as different phase shift settings for the reflecting elements 802 of each subgroup will produce different reflection directions.

As illustrated in FIGS. 13A and 13B, the reflecting signals 1310 and 1360 have different shapes. Generally, a block-wise configuration, such as the block-wise configuration 1300 of FIG. 13A, will result in a wider signal with smaller side lobes than an interlaced configuration, such as the interlaced configuration 1350 of FIG. 13B. Likewise, an interlaced configuration, such as the interlace configuration 1350, will result in a narrower reflected signal with larger side lobes than a block-wise configuration, such as the block-wise configuration 1300. The side lobes may be less pronounced in a block-wise configuration because adjacent reflected signals of the localized reflecting elements 802 of a block-wise subset suppress such side lobes.

FIGS. 13A and 13B illustrate a two-dimensional array 801 of sixty-four reflecting elements 802. However, the array 801 of reflecting elements 802 may include any number of reflecting elements 802. Additionally, although the two-dimensional array 801 is illustrated in a square shape, the two-dimensional array 801 may take a different, non-square shape. For example, the two-dimensional array 801 of reflecting elements 802 may have reflecting elements 802 arranged in a rectangular shape having a larger length than width or larger width than length, a circular shape, or another shape.

FIGS. 14A and 14B illustrate two example hybrid reflecting configurations that incorporate aspects of both block-wise and interlaced configurations. In both FIGS. 14A and 14B, the array 801 of reflecting elements 802 includes a two-dimensional (8×8) array of reflecting elements 802. However, the array 801 of reflecting elements 802 may include any number of reflecting elements. Additionally, although the two-dimensional array 801 of reflecting elements are illustrated in a square shape, the two-dimensional array 801 may take a different, non-square shape. For example, the two-dimensional array 801 of reflecting elements 802 may be arranged in a rectangular shape having a larger length than width or larger width than length, a circular shape, or another shape.

FIG. 14A illustrates a first hybrid configuration 1400. In the first hybrid configuration 1400, reflecting elements 802 are grouped in block-wise subsets in the x-axis and in interlaced subsets in the y-axis. Each reflecting element 802 is a part of both a block-wise subset and an interlaced subset. In the illustration of the array 801, each reflecting element 802 has a left-half circle showing its x-axis (block-wise) subset, and a right-half circle showing its y-axis (interlaced) subset.

More particularly, the first hybrid configuration 1400 includes a plurality of subsets of the array 801 of reflecting elements 802 including four subsets 1402, 1404, 1406, and 1408. In FIG. 14A, to distinguish subsets, each subset is illustrated with a unique fill pattern and one example reflecting element 802 of each subset is labeled as 1402, 1404, 1406, or 1408. Each subset 1402, 1404, 1406, and 1408 includes thirty-two of the reflecting elements 802. The subsets 1402 and 1404 are block-wise subsets, with the left-half of the array of reflecting elements grouped in the subset 1402 and the right-half of the array of reflecting elements 802 grouped in the subset 1404. The subsets 1406 and 1408 are interlaced subsets, with alternating rows of the array of reflecting elements grouped in the subset 1406 and the subset 1408. For example, in the first (top) row, the third row, the fifth row, and the seventh row, reflecting elements 802 are grouped in the subset 1406. Additionally, in the second, fourth, sixth, and eight row, reflecting elements 802 are grouped in the subset 1408.

Although not illustrated, the plurality of subsets of the array 801 of reflecting elements 802 reflect an incoming signal (not shown, but similar to incoming signal 1210) as reflected signals, generally similar to the reflected signals illustrated and described with respect to FIGS. 12A, 12B, 13A, and 13B. Each subset reflects the incoming signal in a respective direction. For example, the reflecting elements 802 of the subset 1402 reflect the incoming signal as a reflected signal in a first direction, the reflecting elements 802 of the subset 1404 reflect the incoming signal as a reflected signal in a second direction, the reflecting elements 802 of the subset 1406 reflect the incoming signal as a reflected signal in a third direction, and the reflecting elements 802 of the subset 1408 reflect the incoming signal as a reflected signal in a fourth direction. As described with respect to the block-wise and interlaced configurations of FIGS. 13A and 13B, the reflected signal from the subsets 1402 and 1404 having reflecting elements 802 in block-wise groups may be generally wider than the reflected signals from the subsets 1406 and 1408 that have reflecting elements 802 in interlaced groups. Similarly, the reflected signals from the subsets 1406 and 1408 may have more pronounced side lobes than the reflected signals from the subsets 1402 and 1404.

In some examples, a reflecting element 802 may be part of two different subsets. For example, the reflecting element 802 may be associated with two reflecting angles, one for each subset. In some examples, the reflecting elements 802 are each configured to phase shift along an x-axis according to a first setting for a first subset and configured to phase shift along a y-axis according to a second setting for a second subset. For example, the weights or directional information (e.g., phase and amplitude) for each reflecting element may be determined for assigned subset (or axis). The weights or directional information may then be multiplied or otherwise combined to provide a phase shift setting for the reflecting element 802 to achieve the reflection desired for each respective subset. For example, the amplitude and phase for each reflecting element 802 may be determined using the following equation:

$${U}_{x , y} = {U}_{x} {U}_{y} ∼ A ( x ) A ( y ) = rect ( \frac{x}{{D}_{x}} ) rect ( \frac{y}{{D}_{y}} ) exp [ i 2 π \frac{x sin {θ}_{0 , x} + y sin {θ}_{0 , y}}{λ} ]$$

where A(x) and A(y) are aperture functions including the amplitude-phase profile of the intended beam reflection, θ_{o,x} is the target angle for the x-axis (first subset), θ_{o,y} is the target angle for the y-axis (second subset), x is the x-position of the reflecting element within the array 801, y is the y-position of the reflecting element 802 within the array 801, Dx is the separation of reflecting elements 802 in the array 801 in the x-direction, and Dy is the separation of reflecting elements 80 in the array 801 in the y-direction.

FIG. 14B illustrates a second hybrid configuration 1450. In the second hybrid configuration 1450, reflecting elements 802 are grouped in block-wise subsets in the y-axis and in interlaced subsets in the x-axis. Each reflecting element 802 is a part of subset that is configured as partially block-wise and partially interlaced. Stated another way, each reflecting element 802 is part of a subset that has a hybrid configuration that is both block-wise and interlaced. More particularly, the second hybrid configuration 1450 includes a plurality of subsets of the array 801 of reflecting elements 802 including four subsets 1452, 1454, 1456, and 1458. In FIG. 14B, to distinguish subsets, each subset is illustrated with a unique fill pattern and one example reflecting element of each subset is labeled as 1452, 1454, 1456, or 1458. Each subset 1452, 1454, 1456, and 1458 includes sixteen of the reflecting elements 802 split between two respective blocks extending along the y-direction. For example, the subset 1452 includes the first and third column of reflecting elements 802, the subset 1454 includes the second and fourth columns of reflecting elements 802, the subset 1456 includes the fifth and seventh columns of reflecting elements 802, and the subset 1454 includes sixth and eighth columns of reflecting elements 802. Accordingly, the subset 1452 is interlaced with the subset 1454 in the x-direction (on the left half of the array 801), and the subset 1456 is interlaced with the subset 1458 in the x-direction (on the right half of the array 801). Further, each column is a grouping of reflecting elements in a block-wise configuration, with each subset 1452, 1454, 1456, and 1458 having two such groupings (i.e., two columns).

Although not illustrated, the plurality of subsets of the array 801 of reflecting elements 802 reflect an incoming signal (not shown, but similar to incoming signal 1210) as reflected signals, generally similar to the reflected signals illustrated and described with respect to FIGS. 12A, 12B, 13A, and 13B. Each subset reflects the incoming signal in a respective direction based on the phase setting of the phase shifting elements of the subset. For example, the reflecting elements 802 of the subset 1452 reflect the incoming signal as a reflected signal in a first direction, the reflecting elements 802 of the subset 1454 reflect the incoming signal as a reflected signal in a second direction, the reflecting elements 802 of the subset 1456 reflect the incoming signal as a reflected signal in a third direction, and the reflecting elements 802 of the subset 1458 reflect the incoming signal as a reflected signal in a fourth direction. As described with respect to the block-wise and interlaced configurations of FIGS. 13A and 13B, the reflected signals from block-wise subsets may be generally wider than the reflected signals from the interlaced subsets. As the subsets 1452, 1454, 1456, and 1458 have hybrid configurations that are both interlaced and block-wise, the reflected signals from these subsets may be generally wider than the reflected signals from purely interlaced subsets, but narrower than the reflected signals from purely block-wise subsets. Additionally, the side lobes of the reflected signals for the subsets 1452, 1454, 1456, and 1458 may be generally smaller than for reflected signals from purely interlaced subsets, but larger than the reflected signals from purely block-wise subsets.

In the above-described example reflecting configurations, the reflecting configurations include two or four subsets. However, the first reflecting configuration may include any number of subsets (e.g., two, three, four, five, six, seven, eight, or more than eight subsets). Further, the particular shapes of the block-wise configurations may vary. For example, in some embodiments, a group of reflecting elements 802 in a block-wise configuration (whether pure or hybrid) may be in a shape of a square, rectangle, circle, oval, or the like. Additionally, the particular spacing between interlaced reflecting elements or distribution pattern may vary. For example, in some embodiments, a group of reflecting elements 802 in an interlaced configuration may be spaced apart by more than one reflecting element. Further Examples Having a Variety of Features:

Example 1: A method, apparatus, and non-transitory computer-readable medium for a controllable reflective surface for wireless communication. The controllable reflective surface includes an array of reflecting elements, each reflecting element comprising a radiating component and a phase-shifting component. The array of reflecting elements is configured to receive a first control signal set that configures the array of reflecting elements into a first reflecting configuration having a first plurality of subsets of the reflecting elements, each subset of the first plurality of subsets configured to reflect radio frequency (RF) signals in a respective direction different from other ones of the first plurality of subsets. The array of reflecting elements is further configured to receive a second control signal set that configures the array of reflecting elements into a second reflecting configuration having a second plurality of subsets of the reflecting elements, each subset of the second plurality of subsets configured to reflect RF signals in a respective direction different from other ones of the second plurality of subsets.

Example 2: A method, apparatus, and non-transitory computer-readable medium of Example 1, wherein the subsets of the first plurality of subsets have a block-wise configuration in which each of the subsets of the first plurality of subsets forms a respective block of localized reflecting elements.

Example 3: A method, apparatus, and non-transitory computer-readable medium of any of Examples 1 to 2, wherein the subsets of the first plurality of subsets have an interlaced configuration in which each of the subsets of the first plurality of subsets forms a distributed group of reflecting elements.

Example 4: A method, apparatus, and non-transitory computer-readable medium of any of Examples 1 to 3, wherein the subsets of the first plurality of subsets have a block-wise configuration in which each of the subsets of the first plurality of subsets forms a respective block of localized reflecting elements, and wherein the subsets of the second plurality of subsets have an interlaced configuration in which each of the subsets of the second plurality of subsets forms a distributed group of reflecting elements.

Example 5: A method, apparatus, and non-transitory computer-readable medium of any of Examples 1 to 4, wherein the first plurality of subsets have a hybrid configuration comprising a reflecting element that is part of both an interlaced subset of the first plurality of subsets and a block-wise subset of the first plurality of subsets.

Example 6: A method, apparatus, and non-transitory computer-readable medium of any of Examples 1 to 5, wherein the first plurality of subsets have a hybrid configuration comprising a reflecting element that has a plurality of axes, each axis associated with one of the subsets of the first plurality of subsets.

Example 7: A method, apparatus, and non-transitory computer-readable medium of any of Examples 1 to 6, wherein the first plurality of subsets have a hybrid configuration comprising a subset of the first plurality of subsets that includes an interlaced portion of the reflecting elements and a block-wise portion of the reflecting elements.

Example 8: A method, apparatus, and non-transitory computer-readable medium for a controller for a controllable reflective surface. The controller includes a processor, a communication interface communicatively coupled to the processor, a panel interface communicatively coupled to the processor, and a memory communicatively coupled to the processor. The controller is configured to receive, with the communication interface, first configuration information for reflecting elements of an array. The controller is further configured to send, with the panel interface, a first configuration control signal set, based on the first configuration information, indicating a first reflecting configuration for the array, the first reflecting configuration having a first plurality of subsets of the reflecting elements, each subset of the first plurality of subsets configured to reflect radio frequency (RF) signals in a respective direction different from other ones of the first plurality of subsets. The controller is further configured to receive, with the communication interface, second configuration information for the reflecting elements of the array. The controller is further configured to send, with the panel interface, a second configuration control signal set, based on the second configuration information, indicating a second reflecting configuration for the array, the second reflecting configuration having a second plurality of subsets of the reflecting elements, each subset of the second plurality of subsets configured to reflect RF signals in a respective direction different from other ones of the second plurality of subsets.

Example 9: A method, apparatus, and non-transitory computer-readable medium of Example 8, wherein the subsets of the first plurality of subsets have a block-wise configuration in which each of the subsets of the first plurality of subsets forms a respective block of localized reflecting elements.

Example 10: A method, apparatus, and non-transitory computer-readable medium of any of Examples 8 to 9, wherein the subsets of the first plurality of subsets have an interlaced configuration in which each of the subsets of the first plurality of subsets forms a distributed group of reflecting elements.

Example 11: A method, apparatus, and non-transitory computer-readable medium of any of Examples 8 to 10, wherein the subsets of the first plurality of subsets have a block-wise configuration in which each of the subsets of the first plurality of subsets forms a respective block of localized reflecting elements, and wherein the subsets of the second plurality of subsets have an interlaced configuration in which each of the subsets of the second plurality of subsets forms a distributed group of reflecting elements.

Example 12: A method, apparatus, and non-transitory computer-readable medium of any of Examples 8 to 11, wherein the first plurality of subsets have a hybrid configuration, the hybrid configuration comprising one or more of: (i) a reflecting element that is part of both an interlaced subset of the first plurality of subsets and a block-wise subset of the first plurality of subsets, or (ii) a subset of the first plurality of subsets that includes an interlaced portion of the reflecting elements and a block-wise portion of the reflecting elements.

Example 13: A method, apparatus, and non-transitory computer-readable medium of any of Examples 8 to 12, wherein the first configuration information includes partition information indicating the first plurality of subsets of the reflecting elements and directional information indicating the respective directions for each subset of the first plurality of subsets.

Example 14: A method, apparatus, and non-transitory computer-readable medium of any of Examples 8 to 13, wherein the controller is further configured to: (i) receive the partition information separately from the directional information, (ii) receive the partition information jointly encoded with the directional information, or (iii) receive the partition information concatenated with the directional information, the partition information and directional information having been separately encoded before concatenation.

Example 15: A method, apparatus, and non-transitory computer-readable medium of any of Examples 8 to 14, wherein the first configuration information is received, with the communication interface, from a base station.

Example 16: A method, apparatus, and non-transitory computer-readable medium for an apparatus for wireless communication. The apparatus includes a processor, a communication interface communicatively coupled to the processor, and a memory communicatively coupled to the processor. The apparatus is configured to transmit, with the communication interface, first configuration information for reflecting elements of an array, wherein the first configuration information indicates a first reflecting configuration for the array, the first reflecting configuration having a first plurality of subsets of the reflecting elements, each subset of the first plurality of subsets configured to reflect radio frequency (RF) signals in a respective direction different from other ones of the first plurality of subsets. The apparatus is further configured to transmit, with the communication interface, second configuration information for the reflecting elements of the array, wherein the second configuration information indicates a second reflecting configuration for the array, the second reflecting configuration having a second plurality of subsets of the reflecting elements, each subset of the second plurality of subsets configured to reflect RF signals in a respective direction different from other ones of the second plurality of subsets.

Example 17: A method, apparatus, and non-transitory computer-readable medium of Example 16, wherein the subsets of the first plurality of subsets have a block-wise configuration in which each of the subsets of the first plurality of subsets forms a respective block of localized reflecting elements.

Example 18: A method, apparatus, and non-transitory computer-readable medium of any of Examples 16 to 17, wherein the subsets of the first plurality of subsets have an interlaced configuration in which each of the subsets of the first plurality of subsets forms a distributed group of reflecting elements.

Example 19: A method, apparatus, and non-transitory computer-readable medium of any of Examples 16 to 18, wherein the subsets of the first plurality of subsets have a block-wise configuration in which each of the subsets of the first plurality of subsets forms a respective block of localized reflecting elements, and wherein the subsets of the second plurality of subsets have an interlaced configuration in which each of the subsets of the second plurality of subsets forms a distributed group of reflecting elements.

Example 20: A method, apparatus, and non-transitory computer-readable medium of any of Examples 16 to 19, wherein the first plurality of subsets have a hybrid configuration, the hybrid configuration comprising one or more of: (i) a reflecting element that is part of both an interlaced subset of the first plurality of subsets and a block-wise subset of the first plurality of subsets, or (ii) a subset of the first plurality of subsets that includes an interlaced portion of the reflecting elements and a block-wise portion of the reflecting elements.

Example 21: A method, apparatus, and non-transitory computer-readable medium of any of Examples 16 to 20, wherein the first configuration information includes partition information indicating the first plurality of subsets of the reflecting elements and directional information indicating the respective directions for each subset of the first plurality of subsets.

Example 22: A method, apparatus, and non-transitory computer-readable medium of any of Examples 16 to 21, wherein the apparatus is further configured to: (i) transmit the partition information separately from the directional information, (ii) transmit the partition information jointly encoded with the directional information, or (iii) separately encode, concatenate, and transmit the partition information and directional information.

Example 23: A method, apparatus, and non-transitory computer-readable medium of any of Examples 16 to 22, wherein the apparatus is a base station.

This disclosure presents several aspects of a wireless communication network with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

The present disclosure uses the word “exemplary” to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The present disclosure uses the term “coupled” to refer to a direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The present disclosure uses the terms “circuit” and “circuitry” broadly, to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-14B may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-14B may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

Applicant provides this description to enable any person skilled in the art to practice the various aspects described herein. Those skilled in the art will readily recognize various modifications to these aspects, and may apply the generic principles defined herein to other aspects. Applicant does not intend the claims to be limited to the aspects shown herein, but to be accorded the full scope consistent with the language of the claims, wherein reference to an element in the singular is not intended to mean “one and only one” unless specifically so stated, but rather “one or more.” Unless specifically stated otherwise, the present disclosure uses the term “some” to refer to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A controllable reflective surface for wireless communication, comprising:
an array of reflecting elements, each reflecting element comprising a radiating component and a phase-shifting component, the array of reflecting elements configured to:
receive a first control signal set that configures the array of reflecting elements into a first reflecting configuration having a first plurality of subsets of the reflecting elements, each subset of the first plurality of subsets configured to reflect radio frequency (RF) signals in a respective direction different from other ones of the first plurality of subsets; and
receive a second control signal set that configures the array of reflecting elements into a second reflecting configuration having a second plurality of subsets of the reflecting elements, each subset of the second plurality of subsets configured to reflect RF signals in a respective direction different from other ones of the second plurality of subsets.

2. The controllable reflective surface of claim 1, wherein the subsets of the first plurality of subsets have a block-wise configuration in which each of the subsets of the first plurality of subsets forms a respective block of localized reflecting elements.

3. The controllable reflective surface of claim 1, wherein the subsets of the first plurality of subsets have an interlaced configuration in which each of the subsets of the first plurality of subsets forms a distributed group of reflecting elements.

4. The controllable reflective surface of claim 1,
wherein the subsets of the first plurality of subsets have a block-wise configuration in which each of the subsets of the first plurality of subsets forms a respective block of localized reflecting elements, and
wherein the subsets of the second plurality of subsets have an interlaced configuration in which each of the subsets of the second plurality of subsets forms a distributed group of reflecting elements.

5. The controllable reflective surface of claim 1, wherein the first plurality of subsets have a hybrid configuration comprising a reflecting element that is part of both an interlaced subset of the first plurality of subsets and a block-wise subset of the first plurality of subsets.

6. The controllable reflective surface of claim 1, wherein the first plurality of subsets have a hybrid configuration comprising a reflecting element that has a plurality of axes, each axis associated with one of the subsets of the first plurality of subsets.

7. The controllable reflective surface of claim 1, wherein the first plurality of subsets have a hybrid configuration comprising a subset of the first plurality of subsets that includes an interlaced portion of the reflecting elements and a block-wise portion of the reflecting elements.

8. A controller for a controllable reflective surface, comprising:
a processor;
a communication interface communicatively coupled to the processor;
a panel interface communicatively coupled to the processor; and
a memory communicatively coupled to the processor,
wherein the controller is configured to:
receive, with the communication interface, first configuration information for reflecting elements of an array;
send, with the panel interface, a first configuration control signal set, based on the first configuration information, indicating a first reflecting configuration for the array, the first reflecting configuration having a first plurality of subsets of the reflecting elements, each subset of the first plurality of subsets configured to reflect radio frequency (RF) signals in a respective direction different from other ones of the first plurality of subsets;
receive, with the communication interface, second configuration information for the reflecting elements of the array; and
send, with the panel interface, a second configuration control signal set, based on the second configuration information, indicating a second reflecting configuration for the array, the second reflecting configuration having a second plurality of subsets of the reflecting elements, each subset of the second plurality of subsets configured to reflect RF signals in a respective direction different from other ones of the second plurality of subsets.

9. The controller of claim 8, wherein the subsets of the first plurality of subsets have a block-wise configuration in which each of the subsets of the first plurality of subsets forms a respective block of localized reflecting elements.

10. The controller of claim 8, wherein the subsets of the first plurality of subsets have an interlaced configuration in which each of the subsets of the first plurality of subsets forms a distributed group of reflecting elements.

11. The controller of claim 8,
wherein the subsets of the first plurality of subsets have a block-wise configuration in which each of the subsets of the first plurality of subsets forms a respective block of localized reflecting elements, and
wherein the subsets of the second plurality of subsets have an interlaced configuration in which each of the subsets of the second plurality of subsets forms a distributed group of reflecting elements.

12. The controller of claim 8, wherein the first plurality of subsets have a hybrid configuration, the hybrid configuration comprising one or more of:
a reflecting element that is part of both an interlaced subset of the first plurality of subsets and a block-wise subset of the first plurality of subsets, or
a subset of the first plurality of subsets that includes an interlaced portion of the reflecting elements and a block-wise portion of the reflecting elements.

13. The controller of claim 8, wherein the first configuration information includes partition information indicating the first plurality of subsets of the reflecting elements and directional information indicating the respective directions for each subset of the first plurality of subsets.

14. The controller of claim 13, wherein the controller is further configured to:
receive the partition information separately from the directional information,
receive the partition information jointly encoded with the directional information, or
receive the partition information concatenated with the directional information, the partition information and directional information having been separately encoded before concatenation.

15. The controller of claim 8, wherein the first configuration information is received, with the communication interface, from a base station.

16. An apparatus for wireless communication, comprising:
a processor;
a communication interface communicatively coupled to the processor; and
a memory communicatively coupled to the processor,
wherein the apparatus is configured to:
transmit, with the communication interface, first configuration information for reflecting elements of an array, wherein the first configuration information indicates a first reflecting configuration for the array, the first reflecting configuration having a first plurality of subsets of the reflecting elements, each subset of the first plurality of subsets configured to reflect radio frequency (RF) signals in a respective direction different from other ones of the first plurality of subsets; and
transmit, with the communication interface, second configuration information for the reflecting elements of the array, wherein the second configuration information indicates a second reflecting configuration for the array, the second reflecting configuration having a second plurality of subsets of the reflecting elements, each subset of the second plurality of subsets configured to reflect RF signals in a respective direction different from other ones of the second plurality of subsets.

17. The apparatus of claim 16, wherein the subsets of the first plurality of subsets have a block-wise configuration in which each of the subsets of the first plurality of subsets forms a respective block of localized reflecting elements.

18. The apparatus of claim 16, wherein the subsets of the first plurality of subsets have an interlaced configuration in which each of the subsets of the first plurality of subsets forms a distributed group of reflecting elements.

19. The apparatus of claim 16,
wherein the subsets of the first plurality of subsets have a block-wise configuration in which each of the subsets of the first plurality of subsets forms a respective block of localized reflecting elements, and
wherein the subsets of the second plurality of subsets have an interlaced configuration in which each of the subsets of the second plurality of subsets forms a distributed group of reflecting elements.

20. The apparatus of claim 16, wherein the first plurality of subsets have a hybrid configuration, the hybrid configuration comprising one or more of:
a reflecting element that is part of both an interlaced subset of the first plurality of subsets and a block-wise subset of the first plurality of subsets, or
a subset of the first plurality of subsets that includes an interlaced portion of the reflecting elements and a block-wise portion of the reflecting elements.

21. The apparatus of claim 16, wherein the first configuration information includes partition information indicating the first plurality of subsets of the reflecting elements and directional information indicating the respective directions for each subset of the first plurality of subsets.

22. The apparatus of claim 21, wherein the apparatus is further configured to:
transmit the partition information separately from the directional information,
transmit the partition information jointly encoded with the directional information, or
separately encode, concatenate, and transmit the partition information and directional information.

23. The apparatus of claim 16, wherein the apparatus is a base station.

24. A method for wireless communication, the method comprising:
receiving first configuration information for reflecting elements of an array;
sending a first configuration control signal set, based on the first configuration information, indicating a first reflecting configuration for the array, the first reflecting configuration having a first plurality of subsets of the reflecting elements, each subset of the first plurality of subsets configured to reflect radio frequency (RF) signals in a respective direction different from other ones of the first plurality of subsets;
receiving second configuration information for the reflecting elements of the array; and
sending a second configuration control signal set, based on the second configuration information, indicating a second reflecting configuration for the array, the second reflecting configuration having a second plurality of subsets of the reflecting elements, each subset of the second plurality of subsets configured to reflect RF signals in a respective direction different from other ones of the second plurality of subsets.

25. The method of claim 24, wherein the subsets of the first plurality of subsets have a block-wise configuration in which each of the subsets of the first plurality of subsets forms a respective block of localized reflecting elements.

26. The method of claim 24, wherein the subsets of the first plurality of subsets have an interlaced configuration in which each of the subsets of the first plurality of subsets forms a distributed group of reflecting elements.

27. The method of claim 24,
wherein the subsets of the first plurality of subsets have a block-wise configuration in which each of the subsets of the first plurality of subsets forms a respective block of localized reflecting elements, and
wherein the subsets of the second plurality of subsets have an interlaced configuration in which each of the subsets of the second plurality of subsets forms a distributed group of reflecting elements.

28. The method of claim 24, wherein the first plurality of subsets have a hybrid configuration comprising a reflecting element that is part of both an interlaced subset of the first plurality of subsets and a block-wise subset of the first plurality of subsets.

29. The method of claim 24, wherein the first plurality of subsets have a hybrid configuration comprising a subset of the first plurality of subsets that includes an interlaced portion of the reflecting elements and a block-wise portion of the reflecting elements.

30. The method of claim 24, wherein the first configuration information includes partition information indicating the first plurality of subsets of the reflecting elements and directional information indicating the respective directions for each subset of the first plurality of subsets.
